(19) United States
(12) Patent Application Publication
(10) Pub. No.: US 2015/0128291 A1
(43) Pub. Date: May 7, 2015

(54) INFORMATION PROCESSING APPARATUS AND INFORMATION PROCESSING METHOD

(71) Applicant: SONY CORPORATION, TOKYO (JP)

(72) Inventors: KATSUYA HYODO, KANAGAWA (JP); KOSUKE YOSHITOMI, KANAGAWA (JP); KUNIAKI TORII, KANAGAWA (JP); HIKOTATSU CHIN, TOKYO (JP)

(21) Appl. No.: 14/518,277

(22) Filed: Oct. 20, 2014

(30) Foreign Application Priority Data
Nov. 1, 2013 (JP) 2013-227939

(51) Int. Cl. G06F 21/60

(52) U.S. Cl. CPC G06F 21/60
USPC 726/28

(57) ABSTRACT

There is provided an information processing apparatus including a user analysis unit configured to analyze a result of detection by a user detection apparatus that detects users neighboring a device and to acquire user attribute information indicating a characteristic of each detected user, and an interface control unit configured to control a mode of presenting information to be provided for the users, the mode being determined based on the user attribute information.

### CROSS REFERENCE TO RELATED APPLICATIONS

This application claims the benefit of Japanese Priority Patent Application JP 2013-227939 filed Nov. 1, 2013, the entire contents of which are incorporated herein by reference.

### BACKGROUND

The present disclosure relates to an information processing apparatus that processes information to be presented to a user and an information processing method therefor.

When the content of display on a device is desired to be changed according to a user neighboring the device, the user himself/herself has to manually change the setting of an application or the device in related art. For example, suppose a case where a parent subscribes paid content by operating a device under so-called parental control, that is, restriction for preventing children from subscribing paid content on his/her own. In this case, it is necessary to manually lift the restriction, for example, by inputting a password. As described above, manual operation such as setting change is necessary in related art, and thus takes trouble.

Hence, the following technology has been proposed. For example, for door locking or an automatic teller machine (ATM) in a bank, a user in front of a device is identified by using a camera or biometrics, and then lock and unlock states are switched according to the combination of user information (for example, JP 2008-248651A and JP 2008-112231A).

### SUMMARY

However, the technologies described in JP 2008-248651A and JP 2008-112231A enable the lock and unlock states to be switched, but do not change a user interface (UI) and the display content themselves to those easy to use for a user of the device. The use of the technologies described in JP 2008-248651A and JP 2008-112231A is limited use such as door locking and use for ATMs in banks. The technologies are not applicable to other electronic devices such as a smartphone, a personal computer, and a television set. In light of the foregoing, it is desirable to provide an information processing apparatus and an information processing method which are novel and improved, and by which a mode of presenting information to be provided for any user neighboring a device can be changed according to the user.

According to an embodiment of the present disclosure, there is provided an information processing apparatus including a user analysis unit configured to analyze a result of detection by a user detection apparatus that detects users neighboring a device and to acquire user attribute information indicating a characteristic of each detected user, and an interface control unit configured to control a mode of presenting information to be provided for the users, the mode being determined based on the user attribute information.

According to an embodiment of the present disclosure, there is provided an information processing method including analyzing, by a user analysis unit, a result of detection by a user detection apparatus that detects users neighboring a device and to acquire user attribute information indicating a characteristic of each detected user, and controlling, by an interface control unit, a mode of presenting information to be provided for the users, the mode being determined based on the user attribute information.

According to an embodiment of the present disclosure, the users neighboring the device are identified, and the mode of presenting information to be presented to the users is controlled according to the user attribute information, the number of users, or the combination of these. This causes the device to automatically change a UI, display content, and the like, thereby enabling provision of the UI and information that are easy to use for the users of the device.

According to the embodiments of the present disclosure described above, the mode of presenting information to be provided for the users neighboring the device can be changed according to the users. Note that the aforementioned advantageous effects are not necessarily limited, and any of advantageous effects described in the specification or other advantageous effects known from the specification may be exerted in addition to or instead of the advantageous effects described above.

### BRIEF DESCRIPTION OF THE DRAWINGS

FIG. 1 is a block diagram illustrating a configuration of a device including an information processing apparatus according to an embodiment of the present disclosure;

FIG. 2 is a flowchart illustrating an information processing method used by the device according to the embodiment;

FIG. 3 is an explanatory diagram that illustrates an example of an information presentation mode determined based on any user neighboring the device according to the embodiment and authorization information on information to be provided for the user, and illustrates a case where the presence of a plurality of users decreases pieces of provided information;

FIG. 4 is an explanatory diagram that illustrates an example of an information presentation mode determined based on any user neighboring the device according to the embodiment and authorization information on information to be provided for the user, and illustrates a case where the presence of a plurality of users increases pieces of provided information;

FIG. 5 is an explanatory diagram for explaining change of an information presentation mode in the device under parental control in Embodiment Example 1;

FIG. 6 is a flowchart illustrating an information-presentation-mode control method used by the device in Embodiment Example 1;

FIG. 7 is an explanatory diagram for explaining change of an information presentation mode in filtering information to be provided for a user in Embodiment Example 2;

FIG. 8 is a flowchart illustrating an information-presentation-mode control method used by the device in Embodiment Example 2;

FIG. 9 is an explanatory diagram for explaining change of an information presentation mode in changing availability of editing information to be provided for a user in Embodiment Example 3;

FIG. 10 is an explanatory diagram for explaining change of an information presentation mode in changing availability of viewing information to be provided for a user in Embodiment Example 4;

FIG. 11 is an explanatory diagram for explaining change of an information presentation mode in changing a state of sharing information to be provided for a user in Embodiment Example 5;

FIG. 12 is an explanatory diagram for explaining change of an information presentation mode in changing availability of displaying information to be provided for a user in Embodiment Example 6;

FIG. 13 is an explanatory diagram for explaining change of an information presentation mode in changing, according to a user who uses the device, the content of information to be provided for the user in Embodiment Example 7;

FIG. 14 is an explanatory diagram for explaining change of an information presentation mode in changing information presentation design according to a user to be provided with information in Embodiment Example 8;

FIG. 15 is an explanatory diagram for explaining change of an information presentation mode in changing availability of executing a function of the device according to a user in Embodiment Example 9;

FIG. 16 is an explanatory diagram for explaining change of an information presentation mode in filtering information to be provided for users operating devices connected to each other through a communication network in Embodiment Example 10;

FIG. 17 is an explanatory diagram for explaining change of an information presentation mode in extending a function of the device according to the number of users operating the device in Embodiment Example 11; and

FIG. 18 is a hardware configuration diagram illustrating an example of a hardware configuration of the device.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Device Configuration Example

1.1. User Detection Apparatus

1.2. Information Processing Apparatus

2. Information-presentation-mode Control Method

3. Embodiment Examples

3.1. Embodiment Example 1: Parental Control

3.2. Embodiment Example 2: Filtering

3.3. Embodiment Example 3: Collaborative Editing

3.4. Embodiment Example 4: Content Viewing

3.5. Embodiment Example 5: Content Sharing

3.6. Embodiment Example 6: Prying-eyes Protection

3.7. Embodiment Example 7: Providing Different Information and Providing Added Information

3.8. Embodiment Example 8: Design Change

3.9. Embodiment Example 9: Function Restriction

3.10. Embodiment Example 10: Remote Filtering

3.11. Embodiment Example 11: Function Extension

3.12. Embodiment Example 12: Presenting Information in Accordance with Distance

4. Hardware Configuration Example

5. Conclusion

### 1. DEVICE CONFIGURATION EXAMPLE

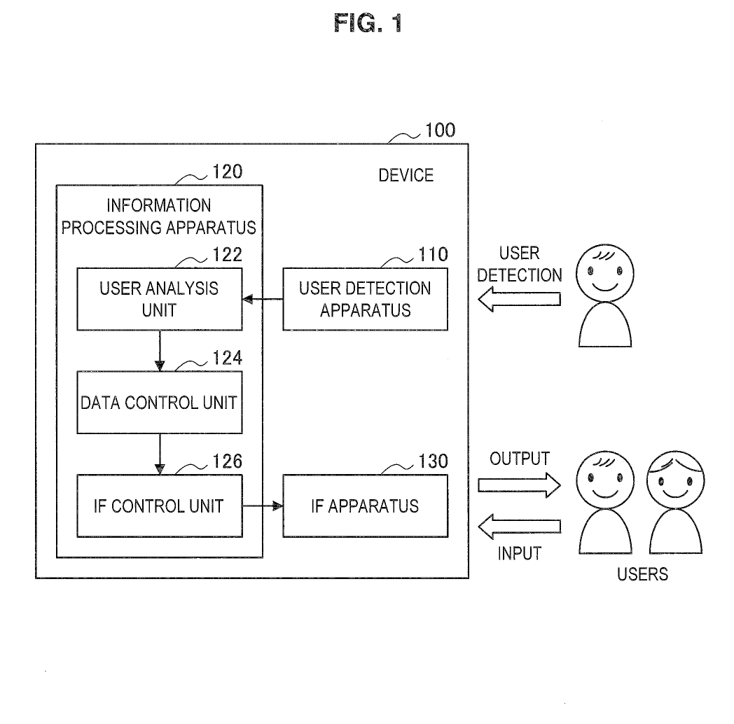

Firstly, a configuration of a device 100 including an information processing apparatus 120 according to an embodiment of the present disclosure will be described with reference to FIG. 1. FIG. 1 is a block diagram illustrating the configuration of the device 100 including the information processing apparatus 120 according to the present embodiment. The device 100 in the present embodiment is a device such as a smartphone, a tablet terminal, a personal computer, a television set, or an electronic book terminal However, the embodiment of the present technology is not limited to these devices that may be the device 100 and applicable to other devices.

The device 100 in FIG. 1 is a device that recognizes any user neighboring the device 100 and changes the content of presentation to the user according to a user attribute of the user. The device 100 includes a user detection apparatus 110, the information processing apparatus 120, and an interface apparatus (hereinafter, referred to as an “IF apparatus”) 130.

All of the user detection apparatus 110, the information processing apparatus 120, and the IF apparatus 130 are provided in the device 100 in the present embodiment. However, the embodiment of the present disclosure is not limited to the example, and, for example, part or all of functions of the user detection apparatus 110, the information processing apparatus 120, and the IF apparatus 130 may be transferred to another device. At this time, a system that functions in the same manner as the device 100 according to the present embodiment is built up by using a home electronic device, a remote server, and like which are connected to enable communication through a communication network such as the Internet. The following description is provided on the assumption that all of the apparatuses are provided in the device 100 as in FIG. 1.

### 1.1. User Detection Apparatus

The user detection apparatus 110 is an apparatus capable of sensing circumstances of the device 100. An imaging apparatus such as a camera, a voice acquisition apparatus such as a microphone, a detection sensor, or the like may be used as the user detection apparatus 110, the detection sensor detecting a distance between the device 100 and a user of the device 100 or the location of the user relative to the device 100. The user detection apparatus 110 acquires one or a plurality of pieces of information on any user neighboring the device 100, as circumstances of the device 100. Accordingly, the user detection apparatus 110 may be configured of a single apparatus by using an apparatus such as a camera, a microphone, or a detection sensor, or configured of a plurality of apparatuses by combining the apparatuses. The user detection apparatus 110 detects image data, voice data, a distance to the user, the location of the user, and the like as neighborhood information of the device 100 and outputs the detection result to the information processing apparatus 120.

### 1.2. Information Processing Apparatus

The information processing apparatus 120 is an apparatus that determines information to be provided for a user and controls a presentation mode for the information. The information processing apparatus 120 according to the present embodiment includes a user analysis unit 122, a data control unit 124, and an interface control unit (hereinafter, referred to as an “IF control unit”) 126.

(User Analysis Unit)

The user analysis unit 122 analyzes neighborhood information such as image data and voice data inputted from the user detection apparatus 110 and acquires user attribute information identifying each of users neighboring the device 100. The user analysis unit 122 acquires the user attribute information from the neighborhood information of the device 100 by using face-image recognition technology, eye-gaze recognition technology, speaker recognition technology, or the like. Here, the neighborhood of the device 100 includes a location not only in a physically short distance but also in a short distance through a communication network such as the Internet. The location in a short distance through a communication network refers to a state of logging in the same service, sharing the screen through the network, or the like.

The user attribute information acquired by the user analysis unit 122 includes a user ID associated with at least one of sorts of user information such as face information, voice information, age, and gender. The user ID is information registered in advance. The user analysis unit 122 acquires a user ID associated with the face information, the voice information, or the like matching a result of detection by the user detection apparatus 110 by analyzing the neighborhood information. Alternatively, the orientation (angle) of the user's face, face category information (such as gender, age, a race, or a countenance), voice category information (such as gender or age), a direction of a sight line of the user, or the like may be acquired as the user attribute information.

When there is a difference from an analysis result in the previous processing, the user analysis unit 122 outputs an analysis result as the user attribute information to the data control unit 124 for each user. Note that an analysis result in the first processing after starting the device 100 is necessarily outputted to the data control unit 124.

(Data Control Unit)

The data control unit 124 is an information control unit that determines information to be provided for users currently neighboring the device 100 based on the user attribute information inputted from the user analysis unit 122. For example, the information to be provided for the users has authorization information indicating whether or not access to the information to be provided is allowed. At this time, the data control unit 124 determines information allowed to be provided for the users based on the authorization information of the information to be provided and on all of acquired pieces of the user attribute information. Upon determination of the data to be provided, the data control unit 124 outputs the relevant information and the user attribute information to the IF control unit 126. Note that in a case where a processing target is not an information-related presentation mode, a case where the user analysis unit 122 fails to identify the user ID, or other cases, the processing by the data control unit 124 can be omitted.

(IF Control Unit)

The IF control unit 126 controls a presentation mode for providing information, based on the information to be provided for the users and the user attribute information which are inputted from the data control unit 124. For example, the IF control unit 126 controls the presentation mode for the information to be presented to the users based on availability of operating the device 100, depending on whether or not every user neighboring the device 100 can handle the information to be provided. Likewise, the IF control unit 126 changes display of the UI, non-display thereof, a UI design, and the like based on the information to be provided for the users and the user attribute information. Note that specific presentation-mode control methods used by the IF control unit 126 will be described later. When determining an information presentation mode, the IF control unit 126 provides the users with the determined presentation mode through the IF apparatus 130.

(IF Apparatus)

The IF apparatus 130 is an apparatus for inputting and outputting information to and from each user. The IF apparatus 130 includes an input apparatus, an output apparatus, and the like, the input apparatus being used by the user for inputting information to the device 100, such as a touch panel, a keyboard, a mouse, or a microphone, the output apparatus being used by the device 100 for outputting information to the user, such as a display or a speaker. Alternatively, the IF apparatus 130 may be an apparatus capable of notifying the user of information by using vibration. Note that information inputted from the input apparatus used as the IF apparatus 130 can also be used as a result of detection by the user detection apparatus 110. At this time, the information inputted from the IF apparatus 130 is used for the analysis for acquiring user attribute information.

### 2. INFORMATION-PRESENTATION-MODE CONTROL METHOD

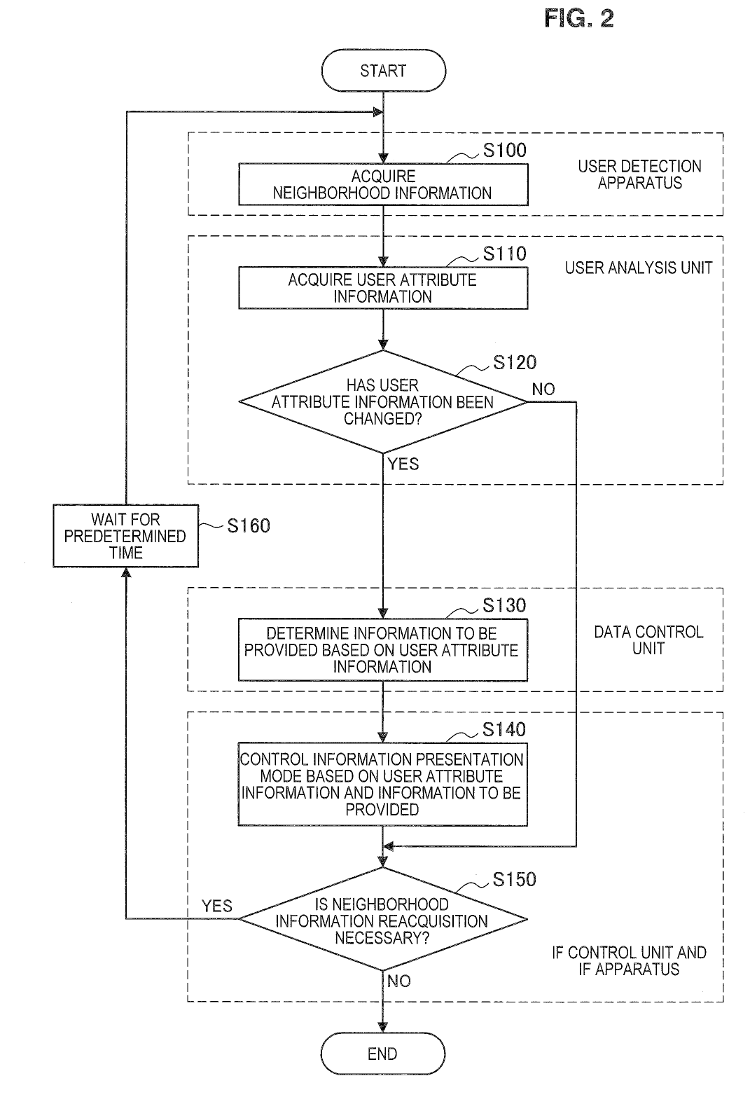

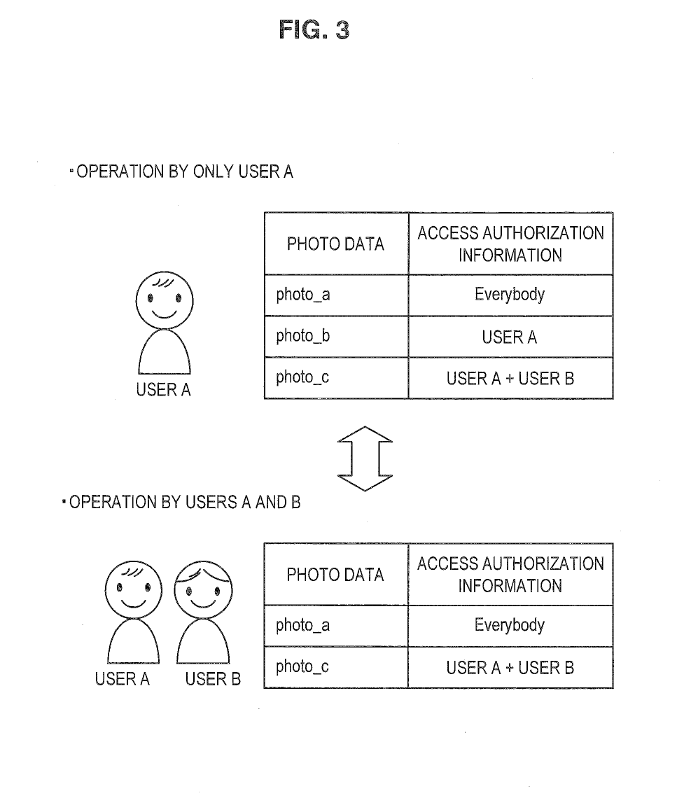

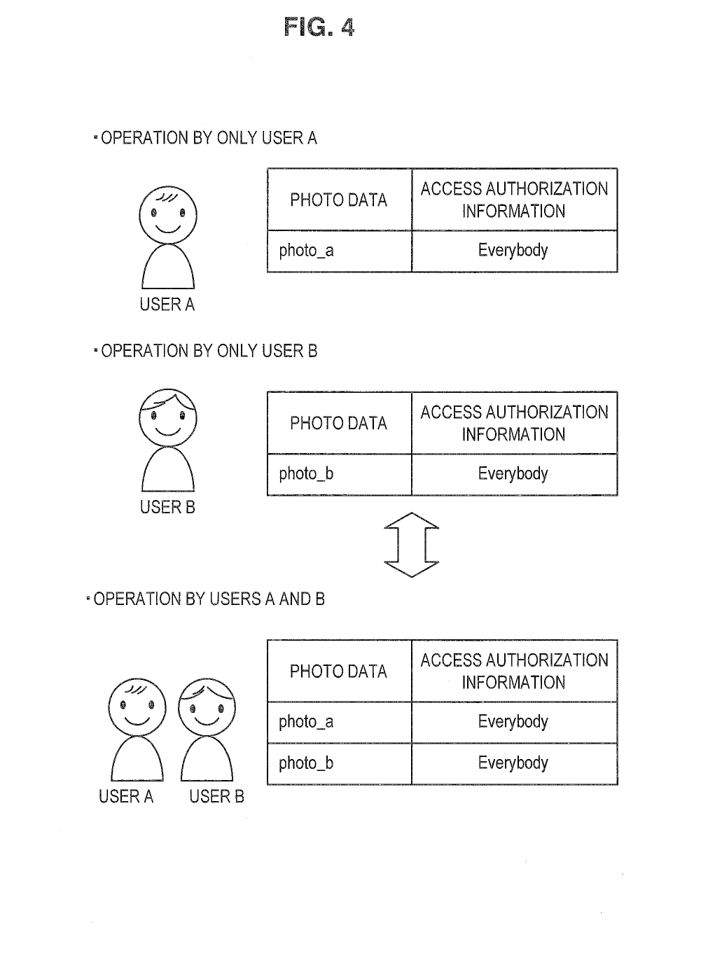

The device 100 according to the present embodiment detects any user neighboring the device 100, analyzes the result of the user detection, and thereby acquires user attribute information. Then, the device 100 determines information to be presented to the user and a presentation mode for the information according to the user attribute information, and provides the user with the determined information in the presentation mode. Hereinafter, a basic information processing method used by the device 100 according to the present embodiment will be described based on a flowchart in FIG. 2 and specific examples in FIGS. 3 and 4.

FIG. 2 is a flowchart illustrating the information processing method used by the device 100 according to the present embodiment. FIG. 3 is an explanatory diagram that illustrates an example of an information presentation mode determined based on any user neighboring the device 100 and authorization information on information to be provided for the user, and illustrates a case where the presence of a plurality of users decreases pieces of provided information. FIG. 4 is an explanatory diagram that illustrates an example of an information presentation mode determined based on any user neighboring the device 100 and authorization information on information to be provided for the user, and illustrates a case where the presence of a plurality of users increases pieces of provided information.

The device 100 according to the present embodiment firstly causes the user detection apparatus 110 to acquire neighborhood information of the device 100 as illustrated in FIG. 2 (S100). For example, when being an imaging apparatus such as a camera, the user detection apparatus 110 takes a photo of the neighborhood of the device 100, for example, on a display surface side of the device 100 or in a range a predetermined distance separated from the device 100, and thereby acquires image data as neighborhood information of the device 100. For example, when being a voice acquisition apparatus such as a microphone, the user detection apparatus 110 acquires voice at the position of the device 100 or near the device 100, and acquires voice data as the neighborhood information of the device 100. The neighborhood information of the device 100 acquired by the user detection apparatus 110 is outputted to the information processing apparatus 120.

Subsequently, the information processing apparatus 120 receiving the input of the neighborhood information of the device 100 causes the user analysis unit 122 to analyze a detection result and thereby to acquire user attribute information (S110). For example, upon receipt of the image data input, the user analysis unit 122 may analyze the image data by using the face-image recognition technology. Examples of the face-image recognition technology include face detection technology of detecting a face in image data. In the face detection technology, for example, the image data is converted into a gray scale image, and then the image is separated into predetermined square regions. The square regions are scanned serially to search for a square region matching a face pattern, and thereby the face in the image data is detected. At this time, a function of discriminating between a face image and non-face image using a statistic method is in advance produced to detect the face. The face pattern can thereby be detected with good accuracy even when there is an individual difference, a face orientation difference, or the like.

From image data, the face-image recognition technology can detect a face and also, for example, estimate an angle of the face orientation, identify the location of a part of the face, judge a face attribute such as gender, age, a race, or a countenance, and identify a person by checking for a person registered in advance. Processing of recognizing these can be performed by using publicly known technology as well as the aforementioned face detection technology. By analyzing the image data using the face-image recognition technology, the number of users neighboring the device 100 can be acquired. By analyzing the image data, for example, information on the face attribute such as the gender, the age, the race, or face attribute information such as the countenance of each user neighboring the device 100 can be acquired as the user attribute information. Further, each user is assigned a user ID specific to the user. When the user ID is associated with the face of the user, users registered in advance are checked using personal identification. The user ID can thereby be acquired as the user attribute information.

In addition, the user analysis unit 122 may also analyze the image data by using the eye-gaze recognition technology to thereby recognize the line of sight of the user. The eye-gaze recognition technology is technology of sensing movement of the eyeballs of the user. By analyzing the image data using the eye-gaze recognition technology, a sight line direction can be acquired as the user attribute information. Based on such user attribute information, it is possible to recognize whether or not the user neighboring the device 100 is watching information provided by the device 100.

Alternatively, when receiving the input of, for example, voice data, the user analysis unit 122 may analyze the voice data by using the speaker recognition technology for recognizing the user. The speaker recognition technology identifies the user, for example, by checking voice information of users registered in advance with information modeled by extracting characteristics of voice from the voice data. Each user is assigned a user ID specific to the user, and when the user ID is associated with the voice of the user, the identified user is checked with the users registered in advance. The user ID can thereby be acquired as the user attribute information. Further, the age or gender of the user can also be identified from the voice data based on the characteristics of the voice, and the language used by the user can also be identified based on the content of a speech.

As described above, the gender, the age, the used language, or the like of the user neighboring the device 100 can be acquired as the user attribute information, by analyzing the voice data using the speaker recognition technology. The user ID can also be acquired as the user attribute information based on these pieces of information. Further, the user analysis unit 122 may acquire as the user attribute information a distance to the user or the location of the user detected by the user detection apparatus 110.

After analyzing the neighborhood information of the device 100 and acquiring the user attribute information, the user analysis unit 122 judges whether the user attribute information has a change from user attribute information acquired in the previous processing (S120). If judging that there is no user-attribute-information change in Step S120, the information processing apparatus 120 executes processing in Step S150. On the other hand, if judging that there is a user-attribute-information change in Step S120, the user analysis unit 122 outputs the acquired user attribute information to the data control unit 124. Note that if the processing in Step S120 is performed for the first time after the device 100 is started, the user attribute information is necessarily outputted to the data control unit 124.

The data control unit 124 receiving the user attribute information input performs processing of changing information to be provided for the user, based on the user attribute information (S130). The information to be provided for the user is determined, for example, depending on an application currently executed by the device 100. For example, when a photo-displaying application is executed, the device 100 provides the user with, for example, photo data stored in the device 100 or in a server connected to the device 100 through the network to be able to communicate with the device 100. Here, the data control unit 124 determines photo data to be provided for the user based on the user attribute information acquired by the user analysis unit 122.

For example, as illustrated in FIG. 3, when the user analysis unit 122 detects only a user A operating the photo-displaying application on the device 100, the user A is provided with pieces of photo data “photo_a”, “photo_b”, and “photo_c”. Each piece of the photo data is associated with access permission information as information related to a user allowed to access the data. In the example in FIG. 3, every user can access “photo_a”, only the user A can access “photo_b”, and the user A and a user B can access “photo_c”. Accordingly, the user A is provided with three pieces of photo data “photo_a”, “photo_b”, and “photo_c” through the IF apparatus 130.

In contrast, the user analysis unit 122 detects the users A and B who operate the photo-displaying application on the device 100, the IF apparatus 130 provides the users A and B with the photo data “photo_a” and “photo_c”. This is because the user B is not permitted to access the photo data “photo_b”. When the plurality of users operate the device 100 as described above, and when the users include even one user not permitted to access certain photo data, the users are not provided with the certain photo data but are provided with only photo data which all of the users neighboring the device 100 can access.

Likewise, as illustrated in FIG. 4 for example, when the user analysis unit 122 detects only the user A operating the photo-displaying application on the device 100, the user A is provided with the photo data “photo_a” owned by the user A. Every user can access “photo_a”. Also, when the user analysis unit 122 detects only the user B operating the photo-displaying application on the device 100, the user B is provided with the photo data “photo_b” owned by the user B. Every user can also access “photo_b”.

In contrast, when the user analysis unit 122 detects the users A and B operating the photo-displaying application on the device 100, the IF apparatus 130 provides the users A and B with the photo data “photo_a” and “photo_b”. This is because every user is permitted to access “photo_a” and “photo_b” owned by the user A and the user B, respectively. In the case of operation by the plurality of users neighboring the device 100 as described above, the users are provided with photo data which all of the users can access, based on access permission information on photo data owned by the users.

The user attribute information is determined in this way in Step S130. The determined information is outputted from the data control unit 124 to the IF control unit 126. Thereafter, the IF control unit 126 controls an information presentation mode for the user based on the user attribute information acquired by the user analysis unit 122 and on the data that is determined by the data control unit 124 and that is to be provided for the user (S140). Here, controlling an information presentation mode refers to processing by which the display content, operation availability, or design of the UI of the IF apparatus 130 is changed when the device 100 provides a user with information.

The IF control unit 126 provides the user with only information inputted from the data control unit 124. This enables only information determined based on the user attribute information by the data control unit 124 to be presented to the user and prevents information from being presented to a user not permitted to access the information. More specific information-presentation-mode control methods used by the IF control unit 126 will be described later.

After providing the user with the information through the IF apparatus 130, the IF control unit 126 judges whether reacquisition of the neighborhood information of the device 100 is necessary (S150). In Step S150, it is judged whether the device 100 itself or an application executed on the device 100 is in a state where the information presentation mode is switchable. If it is judged that the state allows the information presentation mode to be switched, the device 100 waits for a predetermined time (S160), and then executes processing from Step S100 again. On the other hand, it is judged that the state does not allow the information presentation mode to be switched, the device 100 terminates the processing in the flowchart in FIG. 2. The description has heretofore been given of the information-presentation-mode control method used by the device 100 according to the present embodiment.

### 3. EMBODIMENT EXAMPLES

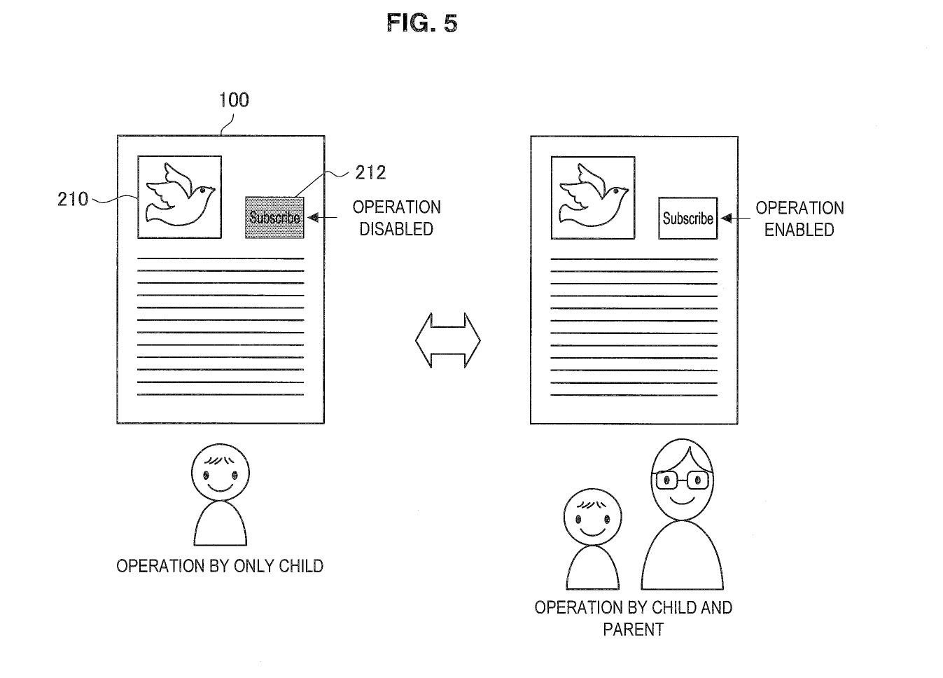

The aforementioned information-presentation-mode control method used by the device 100 is applicable to such cases as below. Hereinafter, embodiment examples of the information-presentation-mode control method will be described based on FIGS. 5 to 17.

### 3.1. Embodiment Example 1

### Parental Control

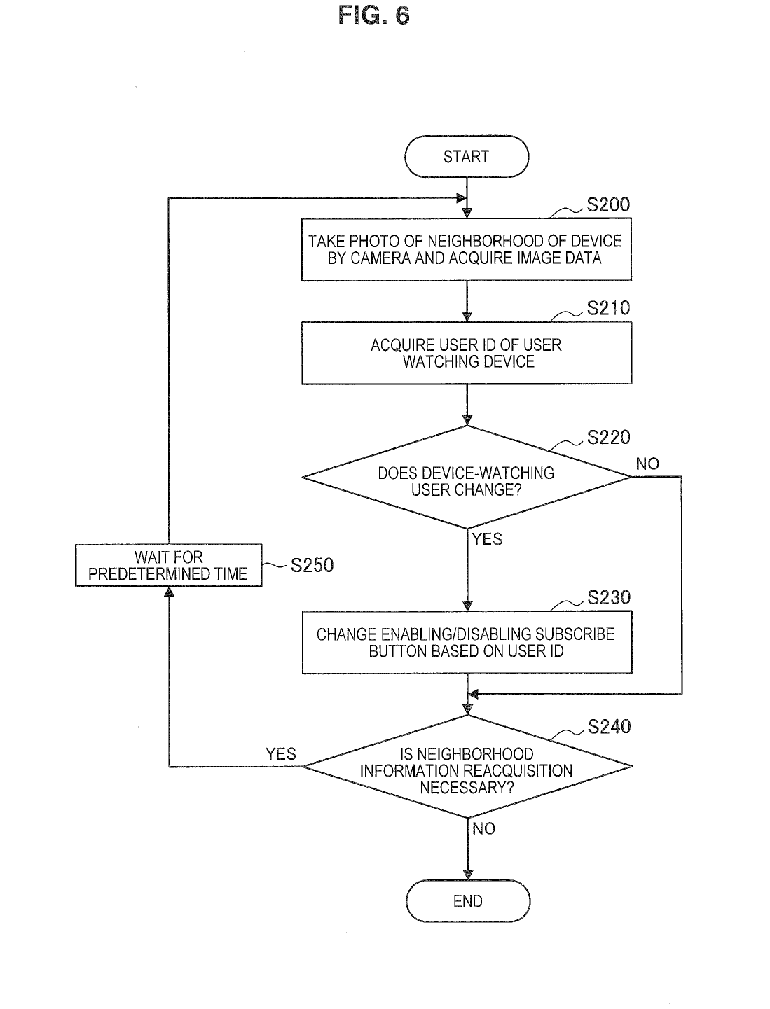

Based on FIGS. 5 and 6, an information-presentation-mode control method used by the device 100 under parental control will be described as Embodiment Example 1 of the information-presentation-mode control method. FIG. 5 is an explanatory diagram for explaining change of an information presentation mode in the device 100 under parental control in Embodiment Example 1. FIG. 6 is a flowchart illustrating the information-presentation-mode control method used by the device 100 in Embodiment Example 1.

The device 100 in the present embodiment example is, for example, a smartphone, a tablet terminal, or a personal computer, and has a function by which a user can subscribe an application, content, and the like by using the device 100. The device 100 is under parental control, for example, to prevent children from subscribing paid content on his/her own.

For example, as illustrated in FIG. 5, an operation for subscribing an application 210 is attempted by using the device 100 under parental control. At this time, if a child operates the device 100 on his/her own, executing the aforementioned information-presentation-mode control method according to the present embodiment on the device 100 disables the function of a subscribe button 212 in the application 210. In contrast, if a parent registered in advance joins in the operation of the device 100, the subscribe button 212 in the application 210 is automatically enabled. As described above, it is possible to perform the parental control while reducing an operation burden on a user in cancelling the parental control.

Specifically, processing in FIG. 6 is executed. The present embodiment example uses a camera as the user detection apparatus 110. Firstly, the camera that is the user detection apparatus 110 takes a photo of the neighborhood of the device 100 and acquires image data as the neighborhood information of the device 100 (S200). The image data acquired by the user detection apparatus 110 is outputted to the information processing apparatus 120.

Next, the information processing apparatus 120 receiving the image data input causes the user analysis unit 122 to analyze a detection result and to thereby acquire user attribute information (S210). In the present embodiment example, a user ID is acquired as the user attribute information. The user analysis unit 122 uses the face-image recognition technology and the eye-gaze recognition technology to identify any user watching the device 100, and acquires the user ID of the user as the user attribute information. Then, based on the user ID, the user analysis unit 122 judges whether there is a change of the user watching the device 100 from a user in the previous processing (S220).

If judging that there is no user-ID change in Step S220, the information processing apparatus 120 executes processing in Step S240. On the other hand, if judging that there is a user-ID change in Step S220, the user analysis unit 122 outputs the acquired user ID to the IF control unit 126. Controlling an information presentation mode in the present embodiment example is controlling availability of operating the subscribe button 212 in the application 210 according to the user neighboring the device 100, and does not result in a content change of information to be provided. For this reason, in the present embodiment example, the user ID acquired by the user analysis unit 122 is outputted to the IF control unit 126, and the processing by the data control unit 124 is skipped. Note that if the processing in Step S220 is performed for the first time after the device 100 is started, the user ID is necessarily outputted to the IF control unit 126.

The IF control unit 126 receiving the user ID from the user analysis unit 122 judges the availability of operating the subscribe button 212 based on the user ID and controls an input apparatus of the IF apparatus 130 based on the judgment result (S230). The IF control unit 126 refers to a subscription-permitted-users list to check if the subscription-permitted-users list includes the user watching the device 100, the subscription-permitted-users list having users recorded therein for whom the subscribe button 212 may be enabled and who are set in advance. In the subscription-permitted-users list, for example, user IDs may be used to manage the users for whom the subscribe button 212 may be enabled. At this time, the IF control unit 126 performs processing of checking if the subscription-permitted-users list includes the user ID acquired by the user analysis unit 122.

If the subscription-permitted-users list includes the user watching the device 100, the IF control unit 126 enables the subscribe button 212. On the other hand, if the subscription-permitted-users list does not include the user watching the device 100, the IF control unit 126 disables the subscribe button 212 while displaying the UI for subscribing the application.

Then, the IF control unit 126 judges whether reacquisition of the neighborhood information of the device 100 is necessary (S240). In Step S240, it is judged whether the device 100 itself or an application executed on the device 100 is in a state where the information presentation mode is switchable. If it is judged that the state allows the information presentation mode to be switched, the device 100 waits for a predetermined time (S250), and then executes processing from Step S200 again. On the other hand, it is judged that the state does not allow the information presentation mode to be switched, the device 100 terminates the processing in the flowchart in FIG. 6.

The information-presentation-mode control method in the device 100 under parental control has heretofore been described as Embodiment Example 1. Applying the information-presentation-mode control method according to the present embodiment enables availability of operating the IF apparatus 130 to be automatically changed according to the user operating the device 100 and thus to reduce an operation burden on the user.

### 3.2. Embodiment Example 2

### Filtering

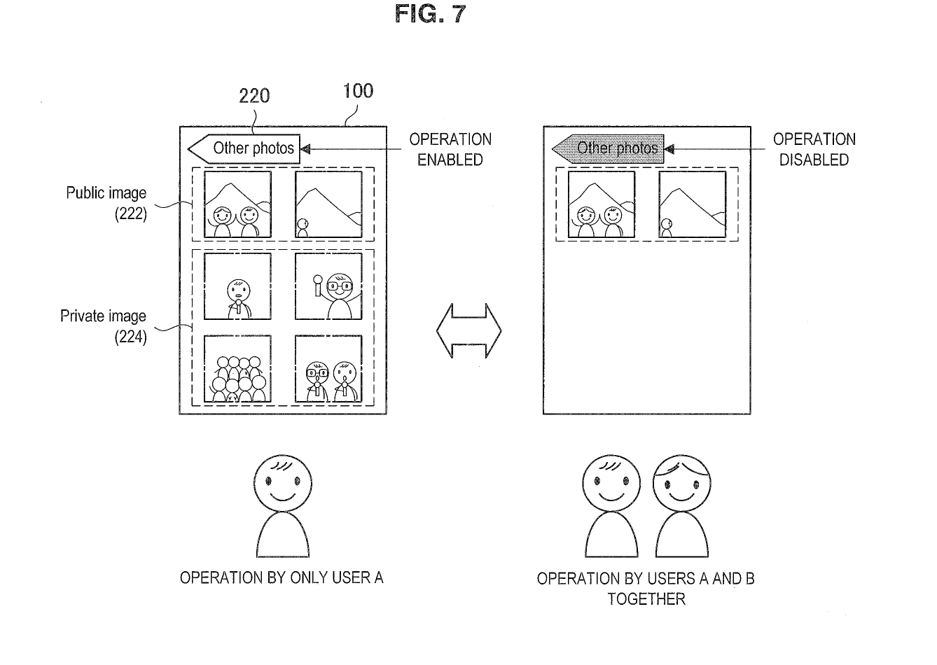

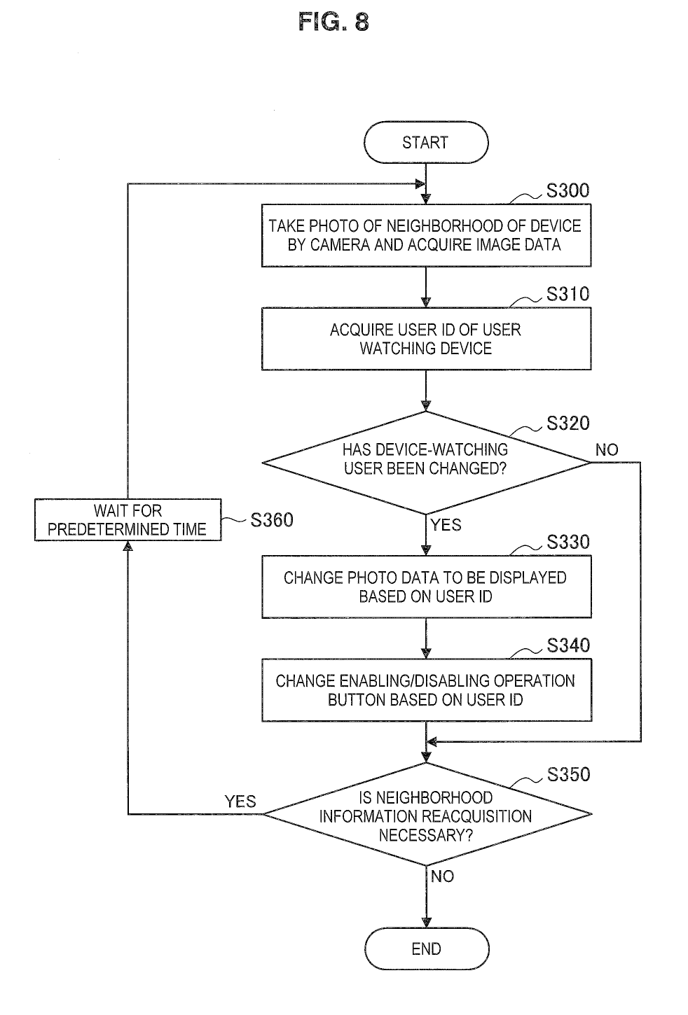

Based on FIGS. 7 and 8, Embodiment Example 2 of the information-presentation-mode control method describes an information-presentation-mode control method by which information to be provided for a user by using the device 100 is filtered. FIG. 7 is an explanatory diagram for explaining change of an information presentation mode in filtering the information to be provided for a user in Embodiment Example 2. FIG. 8 is a flowchart illustrating the information-presentation-mode control method used by the device 100 in Embodiment Example 2.

The device 100 in the present embodiment example is, for example, a smartphone, a tablet terminal, or a personal computer. The device 100 has a function of providing a user with photo data by using the photo-displaying application. In the present embodiment example, photo data to be provided for any user operating the device 100 is changed according to the user.

For example, photo data owned by the user A has photo data (Public Image) 222 allowed to be watched by users as well as the user A and photo data (Private Image) 224 allowed to be watched by only the user A. At this time, as illustrated in FIG. 7, when only the user A operates the device 100, all of pieces of the photo data are displayed on the device 100. In contrast, when the users A and B operate the device 100 together, the photo data 224 allowed to be watched by the user A disappears automatically. Operation of an operation button 220 for watching other photo data is also disabled. This can reduce trouble in which the owner of photo data desired not to be shown other people manually switches, by himself/herself, the photo data according to the user operating the device 100.

Specifically, processing in FIG. 8 is executed. The present embodiment example uses a camera as the user detection apparatus 110. Firstly, the camera that is the user detection apparatus 110 takes a photo of the neighborhood of the device 100 and acquires image data as the neighborhood information of the device 100 (S300). The image data acquired by the user detection apparatus 110 is outputted to the information processing apparatus 120.

Next, the information processing apparatus 120 receiving the image data input causes the user analysis unit 122 to analyze a detection result and to thereby acquire user attribute information (S310). In the present embodiment example, a user ID is acquired as the user attribute information. The user analysis unit 122 uses the face-image recognition technology and the eye-gaze recognition technology to identify any user watching the device 100, and acquires the user ID of the user as the user attribute information. Then, based on the user ID, the user analysis unit 122 judges whether there is a change of the user watching the device 100 from a user in the previous processing (S320).

If judging that there is no user-ID change in Step S320, the information processing apparatus 120 executes processing in Step S350. On the other hand, judging that there is a user-ID change in Step S320, the user analysis unit 122 outputs the acquired user ID to the data control unit 124. Note that if the processing in Step S320 is performed for the first time after the device 100 is started, the user ID is necessarily outputted to the data control unit 124.

The data control unit 124 receiving the user ID input performs processing of changing photo data to be provided to the user, based on the user ID (S330). For example in FIG. 7, if there is an operator change in the device 100 from only the user A to the users A and B, the data control unit 124 recognizes the operator change by receiving the user IDs of the users A and B from the user analysis unit 122. Then, in photo data owned by the users A and B which are allowed to be provided by the photo-displaying application, photo data allowed to be watched by both the users A and B is determined based on access permission information associated with the photo data. In the example in FIG. 7, only the photo data (Public Image) 222 allowed to be watched by both the users A and B is provided for the users A and B. At this time, the data control unit 124 outputs only the photo data (Public Image) 222 to the IF control unit 126.

On the other hand, if there is an operator change in the device 100 from the users A and B to only the user A, the data control unit 124 determines providing all pieces of the photo data 222 and 224 allowed to be watched by the user A, and outputs the pieces of the photo data 222 and 224 to the IF control unit 126. Thereafter, the IF control unit 126 causes the IF apparatus 130 to output the photo data inputted from the data control unit 124. At this time, the IF control unit 126 judges availability of operating the operation button 220 for watching other photo data, based on the user ID, and controls the input apparatus of the IF apparatus 130 based on the judgment result (S340).

For example in FIG. 7, if there is an operator change in the device 100 from only the user A to the users A and B, the IF control unit 126 causes the IF apparatus 130 to display the photo data 222 inputted from the data control unit 124. Accordingly, the photo data (Private Image) 224 is deleted which has been displayed when only the user A operates the device 100 and which can be watched by only the user A.

Then, the IF control unit 126 compares the deleted access permission information of the photo data 224 with the acquired user IDs of the respective users A and B, and thereby recognizes the presence of the user B not allowed to watch the photo data 224 which is allowed to be watched by only the user A. The IF control unit 126 disables the operation button 220 for watching other photos to prevent the user B from watching the photo data 224 allowed to be watched by only the user A. Note that when the display screen of the IF apparatus 130 does not display all pieces of the photo data 222 allowed to be watched by both the users A and B, the operation button 220 may be enabled for watching some pieces of the photo data 222 that are not displayed.

In contrast, if there is an operator change in the device 100 from the users A and B to only the user A, the IF control unit 126 displays all pieces of the photo data 222 and 224 while enabling the operation button 220. This enables the user A to watch all pieces of the photo data 222 and 224 owned by the user A. Then, the IF control unit 126 judges whether reacquisition of the neighborhood information of the device 100 is necessary (S350). In Step S350, it is judged whether the device 100 itself or an application executed on the device 100 is in a state where the information presentation mode is switchable. If it is judged that the state allows the information presentation mode to be switched, the device 100 waits for a predetermined time (S360), and then executes processing from Step S300 again. On the other hand, it is judged that the state does not allow the information presentation mode to be switched, the device 100 terminates the processing in the flowchart in FIG. 8.

Embodiment Example 2 has heretofore described the information-presentation-mode control method by which information to be provided for a user by using the device 100 is filtered. Applying the information-presentation-mode control method according to the present embodiment enables availability of operating the IF apparatus 130 to be automatically changed according to the user operating the device 100 and thus to reduce an operation burden on the user.

### 3.3. Embodiment Example 3

### Collaborative Editing

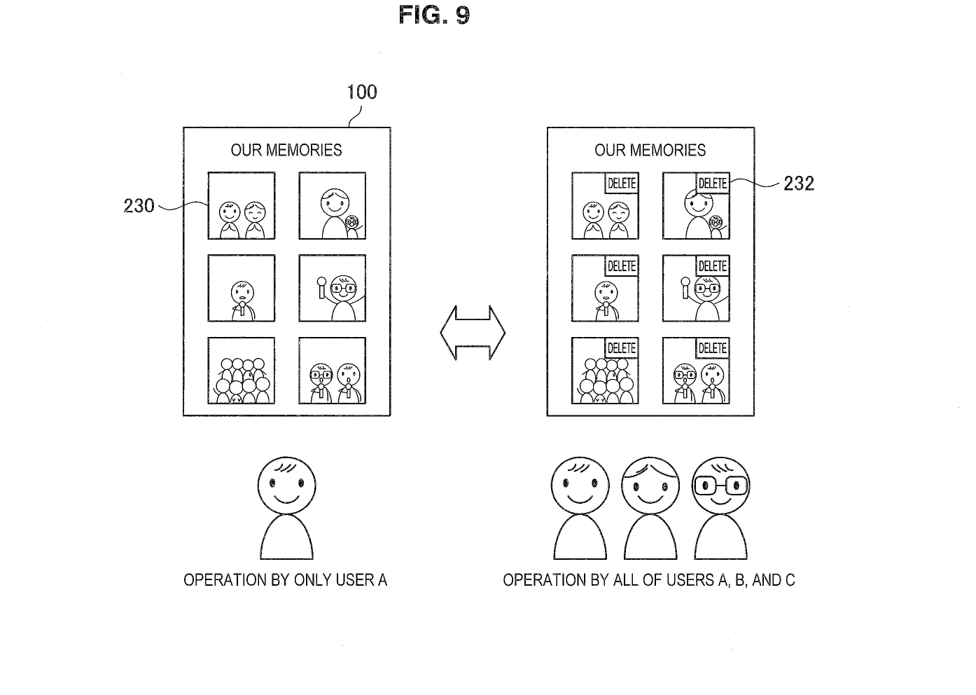

Based on FIG. 9, Embodiment Example 3 of the information-presentation-mode control method describes an information-presentation-mode control method by which availability of editing information to be provided for a user by using the device 100 is changed. FIG. 9 is an explanatory diagram for explaining change of an information presentation mode in changing availability of editing information to be provided for a user in Embodiment Example 3.

The device 100 in the present embodiment example is, for example, a tablet terminal, or a personal computer. The device 100 has a function of providing a user with photo data by using an editing application. In the present embodiment example, availability of editing photo data to be provided for a user operating the device 100 is changed according to the user.

For example, photo data 230 displayed on the device 100 is photo data shared with a plurality of users (for example, the users A and B and a user C) in FIG. 9. The users A, B and C sharing the photo data 230 can freely watch the photo data 230. Nevertheless, photo data shared with a plurality of users is data edited in accordance with the intention of all the sharing users. When at least one of the sharing users is absent, the data may not be edited.

Hence, the information-presentation-mode control method according to the present embodiment manages the editing in the following manner. When only the user A watches the photo data 230, editing such as deleting the photo data 230 is disabled. When all the users are present, editing the photo data 230 is automatically enabled. This prevents information collaboratively managed by a plurality of users from being edited in accordance with the intention of only one of the users, and enables the information to be managed more securely.

The present embodiment example uses a microphone or a camera as the user detection apparatus 110. When the user detection apparatus 110 is the microphone, voice around the device 100 is acquired to acquire voice data as neighborhood information of the device 100. The voice data acquired by the user detection apparatus 110 is analyzed by the user analysis unit 122 of the information processing apparatus 120 by using, for example, the speaker recognition technology, and thus users near the device 100 are identified. Alternatively, when the user detection apparatus 110 is the camera, a photo of the neighborhood of the device 100 is taken to acquire image data as neighborhood information of the device 100. The image data acquired by the user detection apparatus 110 is analyzed by the user analysis unit 122 of the information processing apparatus 120 by using, for example, the face detection and recognition technology, and thus users near the device 100 are identified. Then, the user analysis unit 122 acquires user IDs of the identified users as user attribute information.

Further, the user analysis unit 122 judges whether there is a change of the users watching the device 100 from users in the previous processing, based on the user IDs. If the user IDs have a change, the user analysis unit 122 outputs the acquired user IDs to the IF control unit 126. Controlling an information presentation mode in the present embodiment example is controlling availability of editing the photo data 230 according to the users neighboring the device 100, and does not result in a content change of information to be provided. For this reason, in the present embodiment example, the user IDs acquired by the user analysis unit 122 are outputted to the IF control unit 126, and the processing by the data control unit 124 is skipped. Note that if the processing is performed for the first time after the device 100 is started, the user IDs are necessarily outputted to the IF control unit 126.

The IF control unit 126 receiving the user IDs from the user analysis unit 122 judges the availability of editing the photo data 230 based on the user IDs to control the input apparatus of the IF apparatus 130 based on the judgment result. In other words, the IF control unit 126 refers to a sharing-users list having users recorded therein who share the photo data 230 and thereby judges whether the user IDs of all of the users recorded in the sharing-users list match the user IDs inputted from the user analysis unit 122. At this time, it may be judged whether the user IDs inputted from the user analysis unit 122 completely match, for example, the user IDs in the sharing-users list, or whether the inputted user IDs include at least all the user IDs in the user list.

If every user ID matches, the IF control unit 126 considers that all of the users sharing the photo data 230 operate the device 100 and enables the photo data 230 displayed on the IF apparatus 130 to be edited. For example, as illustrated in the right part of FIG. 9, delete buttons 232 for deleting the photo data 230 may be displayed. Alternatively, selecting the photo data 230 may start the editing application for editing the selected photo data 230. On the other hand, if every user ID does not match, the IF control unit 126 considers that every user sharing the photo data 230 does not operate the device 100 and disables the photo data 230 displayed on the IF apparatus 130 from being edited.

Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing.

Embodiment Example 3 has heretofore described the information-presentation-mode control method by which availability of editing information to be provided for a user is changed. Applying the information-presentation-mode control method according to the present embodiment enables availability of operating the IF apparatus 130 to be automatically changed according to the user operating the device 100 and thus to reduce an operation burden on the user.

### 3.4. Embodiment Example 4

### Content Viewing

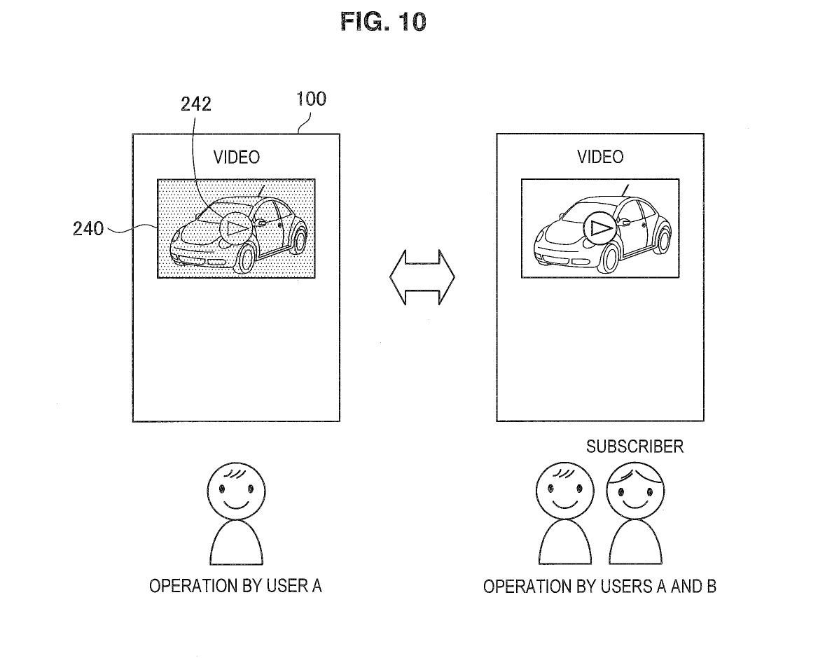

Based on FIG. 10, Embodiment Example 4 of the information-presentation-mode control method describes an information-presentation-mode control method by which availability of viewing information to be provided for a user by using the device 100 is changed. FIG. 10 is an explanatory diagram for explaining change of an information presentation mode in changing availability of viewing information to be provided for a user in Embodiment Example 4.

The device 100 in the present embodiment example is, for example, a smartphone, a tablet terminal, a personal computer, or a television set. The device 100 has a function of reproducing content such as a moving image, music, or an electronic book by using a reproducing application. In the present embodiment example, availability of viewing content to be provided for a user operating the device 100 is changed according to the user.

For example in FIG. 10, assume a situation where a video 240 subscribed by the user B by using the device 100 is viewed. The viewing of the video 240 is set to be allowed only when the user B who is a subscriber is present. For this reason, as illustrated in the left part of FIG. 10, when only the user A who is not the subscriber of the video 240 attempts viewing the video 240, a reproduce button 242 is disabled and becomes in a reproduction-disabled state. In contrast, as illustrated in the right part of FIG. 10, when the user A attempts viewing the video 240 together with the user B who is the subscriber of the video 240, the reproduce button 242 is automatically enabled, and the video 240 can be viewed. This enables, for example, content service providers providing content such as videos to provide users with a more flexible viewing-right-control function.

Processing in the present embodiment example can be performed in the same manner as in Embodiment Example 1. Specifically, for example, a camera is used as the user detection apparatus 110. The camera takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data and to acquire a user ID as user attribute information. The user analysis unit 122 identifies any user operating the device 100 by using the face-image recognition technology and acquires the user ID of the user as the user attribute information. Then, based on the user ID, the user analysis unit 122 judges whether there is a change of the user operating the device 100 from a user in the previous processing.

If judging that there is a user-ID change, the user analysis unit 122 outputs the acquired user ID to the IF control unit 126. Controlling an information presentation mode in the present embodiment example is controlling availability of viewing content according to a user neighboring the device 100, and does not result in a content change of information to be provided. For this reason, in the present embodiment example, the user ID acquired by the user analysis unit 122 is outputted to the IF control unit 126, and the processing by the data control unit 124 is skipped. Note that if the processing is performed for the first time after the device 100 is started, the user ID is necessarily outputted to the IF control unit 126.

Based on the user ID, the IF control unit 126 receiving the user ID from the user analysis unit 122 judges availability of operating the reproduce button 242. The IF control unit 126 refers to a viewing-permitted-users list to check if the viewing-permitted-users list includes the user operating the device 100, the viewing-permitted-users list having users recorded therein who have a right of viewing the video and who are set in advance. In the viewing-permitted-users list, for example, user IDs may be used to manage the users having the right of viewing the video. At this time, the IF control unit 126 performs processing of checking if the viewing-permitted-users list includes the user ID acquired by the user analysis unit 122. When the viewing-permitted-users list includes at least one of users operating the device 100, the IF control unit 126 enables the reproduce button 242. On the other hand, when the viewing-permitted-users list does not include any user operating the device 100, the IF control unit 126 disables the reproduce button 242 while displaying the UI for the video.

Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing. Embodiment Example 4 has heretofore described the information-presentation-mode control method by which availability of viewing information to be provided for a user is changed. Applying the information-presentation-mode control method according to the present embodiment enables availability of operating the IF apparatus 130 to be automatically changed according to the user operating the device 100 and thus to reduce an operation burden on the user.

### 3.5. Embodiment Example 5

### Content Sharing

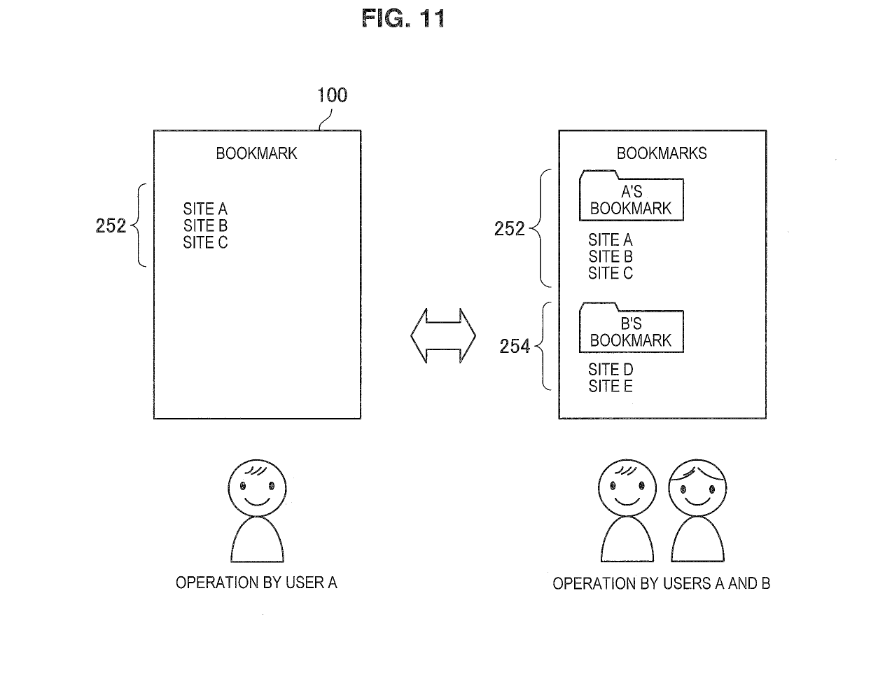

Based on FIG. 11, Embodiment Example 5 of the information-presentation-mode control method describes an information-presentation-mode control method by which a state of sharing information to be provided for a user by using the device 100 is changed. FIG. 11 is an explanatory diagram for explaining change of an information presentation mode in changing a state of sharing information to be provided for a user in Embodiment Example 5. The device 100 in the present embodiment example is, for example, a smartphone, a tablet terminal, or a personal computer. The device 100 has an application, such as a web browser, that handles information resources in the World Wide Web. A user of the web browser can register a favorite web page or the like by using a bookmark function. In the present embodiment example, description is given of a case where bookmark information to be provided for a user operating the device 100 is changed according to the user.

For example, sites A, B, and C are registered in a bookmark 252 of the user A, and sites D and E are registered in a bookmark 254 of the user B. The bookmarks 252 and 254 of the users A and B are open to other users. As illustrated in FIG. 11, when only the user A operates the device 100, only the bookmark 252 of the user A is displayed on the device 100. In contrast, when the users A and B operate the device 100 together, the bookmarks 252 and 254 of the respective users A and B are displayed. As described above, a bookmark displayed on the device 100 is automatically changed according to the user operating the device 100, and thereby trouble is reduced in which each of users of bookmarks notifies the other user of the corresponding bookmark by using e-mail or the like to share the bookmarks.

Processing in the present embodiment example can be performed in the same manner as in Embodiment Example 2. Specifically, for example, a camera is used as the user detection apparatus 110. The camera takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data and to acquire a user ID as user attribute information. The user analysis unit 122 identifies any user operating the device 100 by using the face-image recognition technology and acquires the user ID of the user as the user attribute information. Then, based on the user ID, the user analysis unit 122 judges whether there is a change of the user operating the device 100 from a user in the previous processing.

If judging that there is a user-ID change, the user analysis unit 122 outputs the acquired user ID to the data control unit 124. Based on the user ID, the data control unit 124 changes a bookmark to be provided for a user. For example in FIG. 11, if there is an operator change in the device 100 from only the user A to the users A and B, the data control unit 124 determines providing the bookmarks 252 and 254 of the respective users A and B and outputs the bookmarks 252 and 254 to the IF control unit 126. At this time, if information registered in the bookmark 252 of the user A overlaps with information registered in the bookmark 254 of the user B, a result of merging the information may be provided for the users A and B. In contrast, if there is an operator change in the device 100 from the users A and B to only the user A, the data control unit 124 determines providing only the bookmark 252 of the user A and outputs the bookmark 252 to the IF control unit 126. Note that the processing is performed for the first time after the device 100 is started, the information to be provided for each user is necessarily outputted to the IF control unit 126.

The IF control unit 126 receiving, from the data control unit 124, the information to be provided for the user through the IF apparatus 130 causes the IF apparatus 130 to output the information. For example, when only one user operates the device 100, the IF control unit 126 may cause the IF apparatus 130 to display the content of a bookmark of the user. When a plurality of users operate the device 100, the IF control unit 126 may cause the IF apparatus 130 to display, together with the content, the names of the users for which bookmarks are registered. Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing.

Embodiment Example 5 has heretofore described the information-presentation-mode control method by which a state of sharing information to be provided for a user is changed by the device 100. Applying the information-presentation-mode control method according to the present embodiment enables availability of operating the IF apparatus 130 to be automatically changed according to the user operating the device 100 and thus to reduce an operation burden on the user.

### 3.6. Embodiment Example 6

### Prying-Eyes Protection

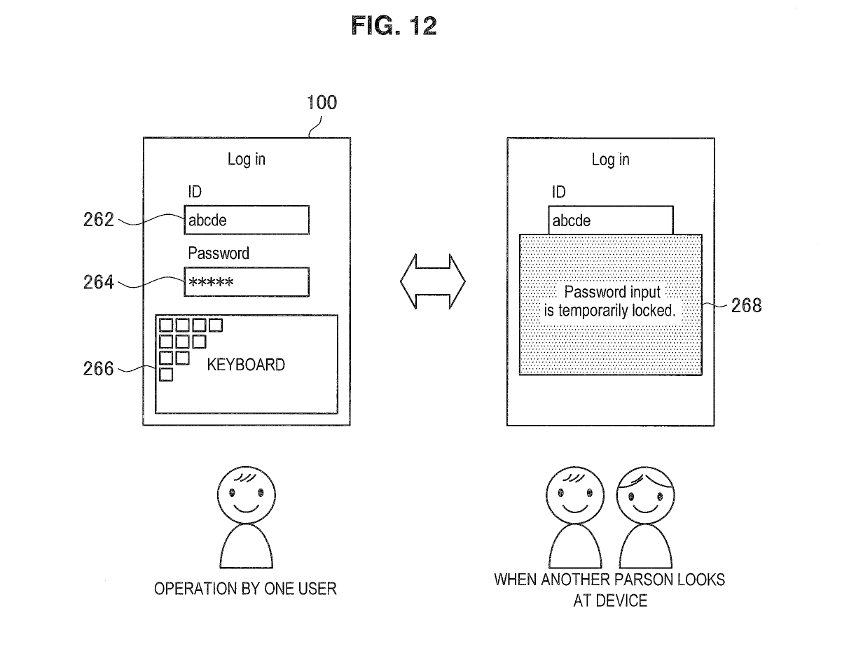

Based on FIG. 12, Embodiment Example 6 of the information-presentation-mode control method describes an information-presentation-mode control method by which availability of displaying information to be provided for a user by using the device 100 is changed. FIG. 12 is an explanatory diagram for explaining change of an information presentation mode in changing availability of displaying information to be provided for a user in Embodiment Example 6. The device 100 in the present embodiment example is, for example, a smartphone, a tablet terminal, or a personal computer. The device 100 has a function of inputting authentication information displayed at the time of log-in or the like of the device 100. For example, as illustrated in the left part of FIG. 12, an ID input box 262 for inputting a log-in ID, a password input box 264 for inputting a password, and a keyboard 266 for inputting information are displayed on a log-in screen displayed on the device 100.

When only one user operates the device 100 at the time of displaying the log-in screen as in the left part of FIG. 12, the ID input box 262, the password input box 264, and the keyboard 266 are visible. Here, while a user is inputting a password, the other user neighboring the device 100 looks at the device 100. At this time, as in the right part of FIG. 12, the device 100 automatically pauses the authentication input function and notifies the user of the prying eyes by using a dialog 268. At this time, the password input box 264 and the keyboard 266 are not displayed, and thus a risk of showing the other user the password can be reduced.

In processing in the present embodiment example, for example, a camera used as the user detection apparatus 110 takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data and to acquire a user ID as user attribute information. The user analysis unit 122 identifies any user neighboring the device 100 by using the face-image recognition technology and the eye-gaze recognition technology, and acquires the user ID as the user attribute information. At this time, an eye-gaze state of the user is also acquired to judge whether the user watches the device 100. Then, based on the user ID, the user analysis unit 122 judges whether there is a change of the user operating the device 100 from a user in the previous processing.

If judging that there is a user-ID change, the user analysis unit 122 outputs the acquired user ID to the IF control unit 126. Controlling an information presentation mode performed in the present embodiment example is controlling by which whether to display information is changed according to the user neighboring the device 100 and does not result in a content change of the information to be provided. For this reason, in the present embodiment example, the user ID acquired by the user analysis unit 122 is outputted to the IF control unit 126, and the processing by the data control unit 124 is skipped. Note that if the processing is performed for the first time after the device 100 is started, the user ID is necessarily outputted to the IF control unit 126.

Upon detection of any other user than the user operating the device 100, the IF control unit 126 receiving the user ID from the user analysis unit 122 checks the eye-gaze state of the other user. Then, when it is judged that the other user looks at the device 100 while the user operating the device 100 is inputting the password, the IF control unit 126 pauses the authentication input function and notifies the user operating the device 100 of the prying eyes by using the dialog 268. Note that except when the other user looks at the device 100 while the user operating the device 100 is inputting the password, the IF control unit 126 enables the password input. Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing.

Embodiment Example 6 has heretofore described the information-presentation-mode control method by which availability of displaying information to be provided for a user is changed. Applying the information-presentation-mode control method according to the present embodiment enables availability of operating the IF apparatus 130 to be automatically changed according to the user operating the device 100 and thus to reduce an operation burden on the user.

### 3.7. Embodiment Example 7

### Providing Different Information and Providing Added Information

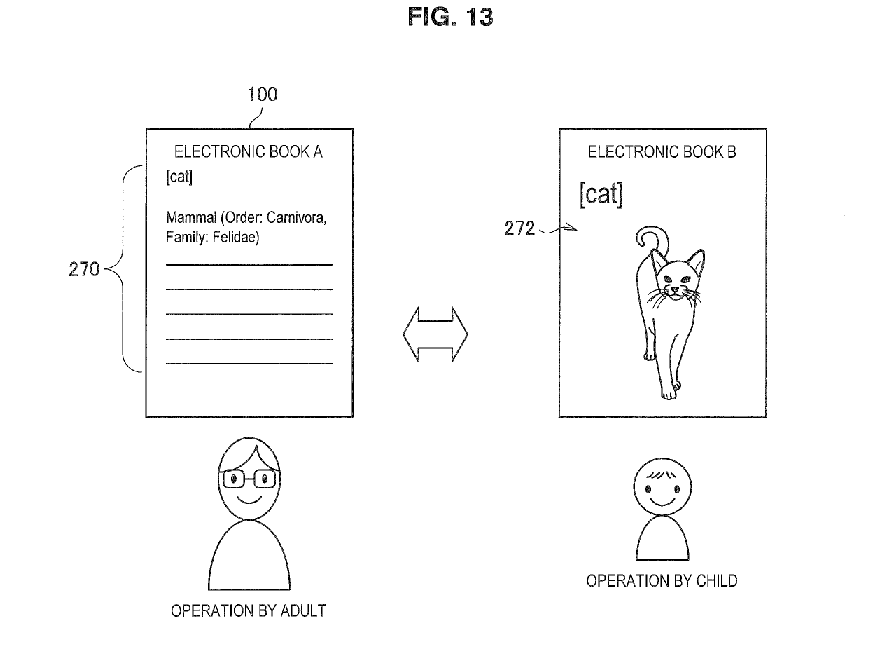

Based on FIG. 13, Embodiment Example 7 of the information-presentation-mode control method describes an information-presentation-mode control method by which the content of information to be provided for a user by using the device 100 is changed by providing different information based on user attribute information or by providing added information. FIG. 13 is an explanatory diagram for explaining change of an information presentation mode in changing, according to a user who uses the device, the content of information to be provided for the user in Embodiment Example 7.

The device 100 in the present embodiment example is, for example, a smartphone, a tablet terminal, a personal computer, or an electronic book terminal The device 100 is a device by which an electronic book can be viewed, and has, for example, an electronic-book application. The present embodiment example shows an example of presenting the user operating the device 100 with information suitable for the user in content.

For example, FIG. 13 illustrates a case where information on a “cat” in an electronic book is provided for a user. When a user operating the device 100 is an adult as in the left part of FIG. 13, a sentence description 270 is presented as the information on the “cat”. In contrast, when the user operating the device 100 is a child as in the left part of FIG. 13, an illustration 272 is presented as the information on the “cat”. This can provide adults with detailed information and children with easy-to-understand information with illustration, larger size characters, or the like. The content of provided information is automatically changed in this way, according to the user operating the device 100, and thereby an operation burden on the user can be reduced.

In processing in the present embodiment example, for example, a camera used as the user detection apparatus 110 takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data. The user analysis unit 122 identifies any user neighboring the device 100 by using the face-image recognition technology, and acquires the age of the user as the user attribute information.

In the present embodiment example, the user is classified as a child or an adult based on the age of the user. For example, a user aged 11 or younger is judged as a child, while a user aged 12 or older is judged as an adult. The age classification setting is not limited to the example, and any classification can be set. In addition, not only the two categories of an adult and a child but also three or more categories may be set. Alternatively, the user does not have to be classified based on the age, but may be judged as an adult or a child by using the age of the user acquired by the user analysis unit 122.

The user analysis unit 122 classifies the user as a child or an adult based on the acquired age of the user, and thereafter judges whether there is a change of the classification of the user operating the device 100 from the classification of a user operating the device 100 in the previous processing. When judging that there is a change of the user classification, the user analysis unit 122 outputs the user classification to the data control unit 124. When there is information suitable in content for the age of a user requesting for information provision, the data control unit 124 determines providing the user with the information matching the classification of the user. The data control unit 124 outputs the determined information to the IF control unit 126.

The IF control unit 126 displays the information inputted from the data control unit 124 on the device 100. At this time, the IF control unit 126 may change the character size, design, and the like in providing the information, according to the classification of the user operating the device 100. As described above, the content of information can be changed according to the age of the user operating the device 100.

Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing.

Embodiment Example 7 has heretofore described the information-presentation-mode control method by which the content of information to be provided for a user is changed. Applying the information-presentation-mode control method according to the present embodiment enables availability of operating the IF apparatus 130 to be automatically changed according to the user operating the device 100 and thus to reduce an operation burden on the user.

Note that the content of information is changed according to the age of the user operating the device 100 in the present embodiment example, but the embodiment of the present technology is not limited to the example. For example, when information to be provided for a user is described in Japanese, the following configuration can be employed based on the age of the user. Reading of Chinese characters in common use is not displayed when the user is an adult, and may automatically be displayed for each character when the user is a child. This can provide adults easy-to-read electronic books while reducing unnecessary display, and enables children to read electronic books using even difficult Chinese characters with the reading of the Chinese characters being provided as added information. Further, in addition to changing the content of information according to the age of the user, the present embodiment example is applicable to, for example, changing a language for information according to the race of the user.

### 3.8. Embodiment Example 8

### Design Change

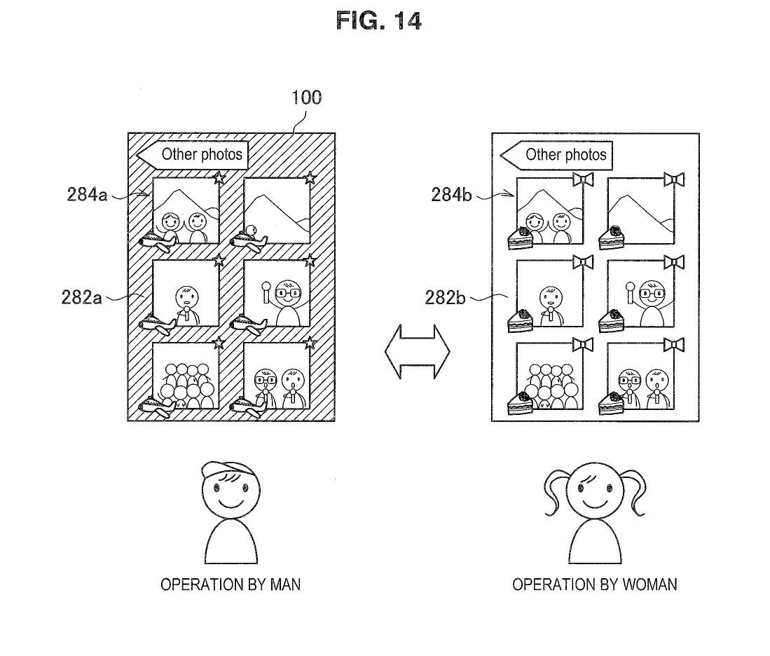

Based on FIG. 14, Embodiment Example 8 of the information-presentation-mode control method describes an information-presentation-mode control method by which design in presenting information to a user by using the device 100 is changed according to the user. FIG. 14 is an explanatory diagram for explaining change of an information presentation mode in changing information presentation design according to the user to be provided with the information in Embodiment Example 8.

The device 100 in the present embodiment example is, for example, a smartphone, a tablet terminal, or a personal computer. The device 100 has, for example, a photo-displaying application. The present embodiment example shows an example in which design in presenting information to a user operating the device 100 is changed according to the user. For example, as illustrated in FIG. 14, a background 282 and frames 284 for displayed photo data are changed according to the gender of the user using the device 100.

As illustrated in the left part of FIG. 14, when a man operates the device 100, the device 100 displays a background 282a and frames 284a for photo data for men. In contrast, as illustrated in the right part of FIG. 14, when a woman operates the device 100, the device 100 displays a background 282b and frames 284b for photo data for women. This enables a user to use the application in design suitable for the user.

In processing in the present embodiment example, for example, a camera used as the user detection apparatus 110 takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data. The user analysis unit 122 identifies any user neighboring the device 100 by using the face-image recognition technology, and acquires gender of the user as the user attribute information.

Next, the user analysis unit 122 judges whether there is a change of the acquired gender of the user from gender in the previous processing. If judging that there is a change of the user's gender, the user analysis unit 122 outputs the acquired gender of the user to the IF control unit 126. Controlling an information presentation mode performed in the present embodiment example is controlling change of application design according to the user neighboring the device 100, and does not result in a content change of information to be provided. For this reason, in the present embodiment example, the user's gender acquired by the user analysis unit 122 is outputted to the IF control unit 126, and the processing by the data control unit 124 is skipped. Note that if the processing is performed for the first time after the device 100 is started, the user's gender is necessarily outputted to the IF control unit 126.

According to the gender of the user operating the device 100, the IF control unit 126 determines design in presenting information and thus presents the information. In this way, the design of the application in presenting information can be changed according to the gender of the user operating the device 100. Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing.

Embodiment Example 8 has heretofore described the information-presentation-mode control method by which design in providing a user with information is changed. Applying the information-presentation-mode control method according to the present embodiment enables availability of operating the IF apparatus 130 to be automatically changed according to the user operating the device 100 and thus to provide the user with application operation suitable for the user's gender. Note that the case of changing an application according to the user's gender has heretofore been described in the present embodiment example, but the embodiment of the present technology is not limited to the example. For example, a user ID may be identified as user attribute information to change the design to design suitable for the taste of the user. Alternatively, the age of the user may be acquired as the user attribute information to change the design according to the age of the user.

### 3.9. Embodiment Example 9

### Function Restriction

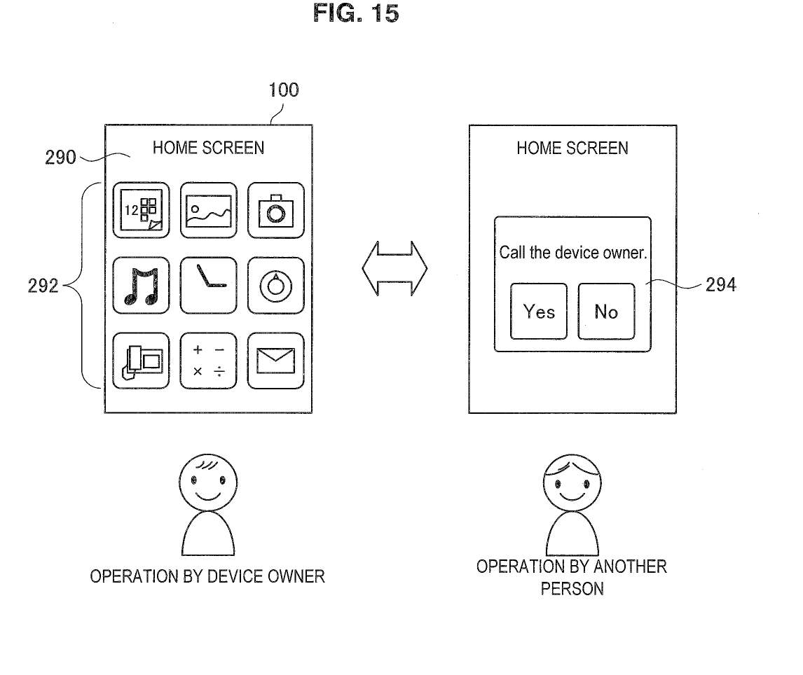

Based on FIG. 15, Embodiment Example 9 of the information-presentation-mode control method describes an information-presentation-mode control method by which availability of executing a function of the device 100 is changed according to a user. FIG. 15 is an explanatory diagram for explaining change of an information presentation mode in changing availability of executing a function of the device 100 according to the user in Embodiment Example 9.

The device 100 in the present embodiment example is, for example, a smartphone, a tablet terminal, or a personal computer. The device 100 has various functions, and execution of each function can be restricted according to the user. The present embodiment example shows an example of a case where an execution-disabling restriction is automatically imposed on a function which a user operating the device 100 is not authorized to execute. For example, a function of unlocking the device 100 is provided to prevent any other user than the owner of the device 100 from operating the device 100. However, the user other than the owner of the device 100 might unlock the device 100 in some way. When the owner of the device 100 unlocks the device 100, a home screen 290 for an ordinary case is displayed as illustrated in the left part of FIG. 15, and the owner can operate icons 292 for executing the functions.

In contrast, when any other user than the owner of the device 100 unlocks the device 100, the information-presentation-mode control method in the present embodiment causes a dialog 294 to be displayed as illustrated in the right part of FIG. 15, the dialog 294 being, for example, for checking whether to call the owner. As described above, the user other than the owner is prevented from using any other function than the function of calling the owner. When the owner loses the device 100, this can provide a way of communicating with the device owner, while preventing the others from abusing the device 100.

In processing in the present embodiment example, for example, a camera used as the user detection apparatus 110 takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data by using the face-image recognition technology, to identify any user neighboring the device 100, and to acquire a user ID as user attribute information. Then, based on the user ID, the user analysis unit 122 judges whether there is a change of the user operating the device 100 from a user in the previous processing.

If judging that there is a user-ID change, the user analysis unit 122 outputs the acquired user ID to the IF control unit 126. Controlling an information presentation mode performed in the present embodiment example is controlling by which execution of the corresponding function of the device 100 is restricted according to the user operating the device 100, and thus the content of information to be provided does not have to be acquired. For this reason, in the present embodiment example, the user ID acquired by the user analysis unit 122 is outputted to the IF control unit 126, and the processing by the data control unit 124 is skipped. Note that if the processing is performed for the first time after the device 100 is started, the user ID is necessarily outputted to the IF control unit 126.

The IF control unit 126 receiving the user ID from the user analysis unit 122 judges whether the user ID of the user operating the device 100 matches the user ID of the owner of the device 100 registered in advance. When these user IDs match, the IF control unit 126 enables all the functions to be executed, and displays a home screen, for example, as illustrated in the left part of FIG. 15 after unlocking the device 100. On the other hand, when the user IDs do not match, the IF control unit 126 restricts executable functions, executes the function of calling the owner after unlocking the device 100, and displays the dialog 294 as illustrated, for example, in the right part of FIG. 15.

Thereafter, the device 100 judges whether reacquisition of the neighborhood information of the device 100 is necessary. If judging that the reacquisition is necessary, the device 100 waits for a predetermined time, and then repeats the processing from the acquisition of the neighborhood information of the device 100. On the other hand, if judging that the reacquisition of the neighborhood information is not necessary, the device 100 terminates the processing. Embodiment Example 9 has heretofore described the information-presentation-mode control method by which availability of executing a function of the device 100 is changed according to the user. Applying the information-presentation-mode control method according to the present embodiment enables function restriction to be automatically imposed according to the user operating the device 100 and thus to enhance security of the device 100.

### 3.10. Embodiment Example 10

### Remote Filtering

Embodiment Example 11 of the information-presentation-mode control method is an example in which information is filtered according to a user of the device 100, like Embodiment Example 2. Embodiment Example 11 is different from Embodiment Example 2 in a situation where the users A and B operate their respective devices 100 connected to each other through a communication network 10 such as the Internet. In the present embodiment example, installation of the user detection apparatus 110 can be omitted, and information inputted by using an input function of the IF apparatus 130 is used as user attribute information. For example, information (for example, a user ID) used by each user as a log-in ID in operating the corresponding device 100 connected through the communication network 10 is used as user attribute information. Note that in the present embodiment example, each user operating the corresponding device 100 connected through the communication network 10 is regarded as a user neighboring the device 100.

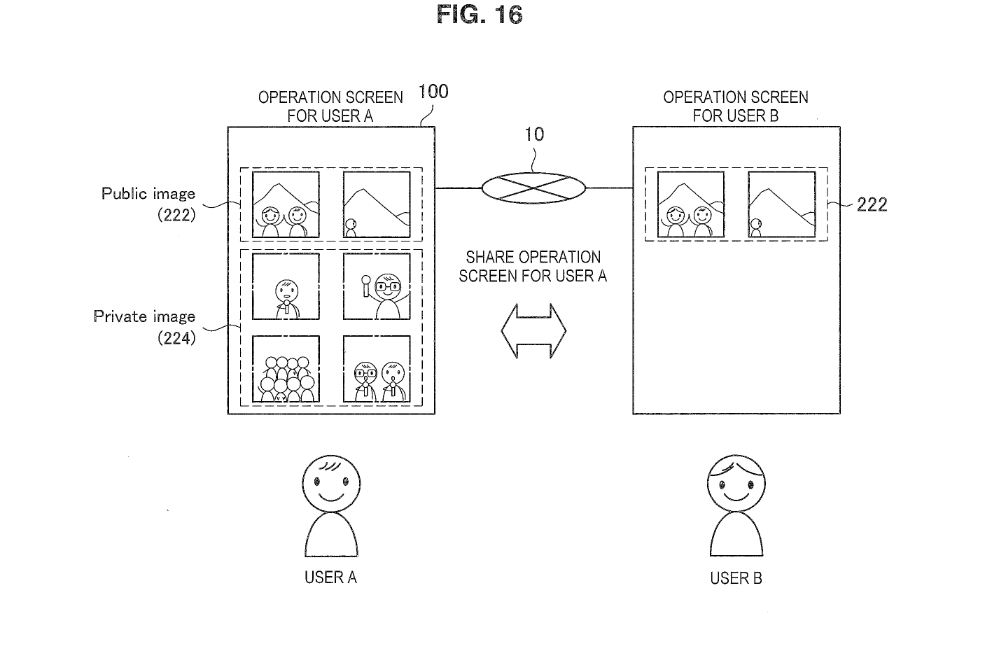

The user ID inputted from the IF apparatus 130 is outputted to the data control unit 124. Based on the user ID, the data control unit 124 determines photo data to be displayed on the device 100 used by the corresponding user. The determination method can be performed in the same manner as in Embodiment Example 2. For example, in the example in FIG. 16, the user A is provided with the photo data (Public Image) 222 allowed to be watched by both the users A and B and the photo data (Private image) 224 allowed to be watched by only the user A. In contrast, the user B is provided with only the photo data (Public Image) 222 allowed to be watched by both the users A and B. The data control unit 124 outputs to the IF control unit 126 the determined photo data to be provided for the corresponding user.

The IF control unit 126 outputs, to the device 100 operated by the user, the photo data that is inputted from the data control unit 124 and that is to be provided for the user. This causes the device 100 of the user A to display the photo data 222 and 224 and the device 100 of the user B to display the photo data 222. This can reduce trouble in which a photo desired not to be shown other people is manually changed according to the circumstances. Note that in the present embodiment example, the processing by the data control unit 124 and the IF control unit 126 may be executed by one of the devices 100 of the users A and B. Alternatively, the processing by the data control unit 124 and the IF control unit 126 may be executed by an information processing apparatus other than the devices 100 of the users A and B connected through the communication network 10. As described above, also when the users use the respective devices 100 connected to each other through the communication network 10, an information presentation mode can be controlled, in the same manner as in Embodiment Example 2.

### 3.11. Embodiment Example 11

### Function Extension

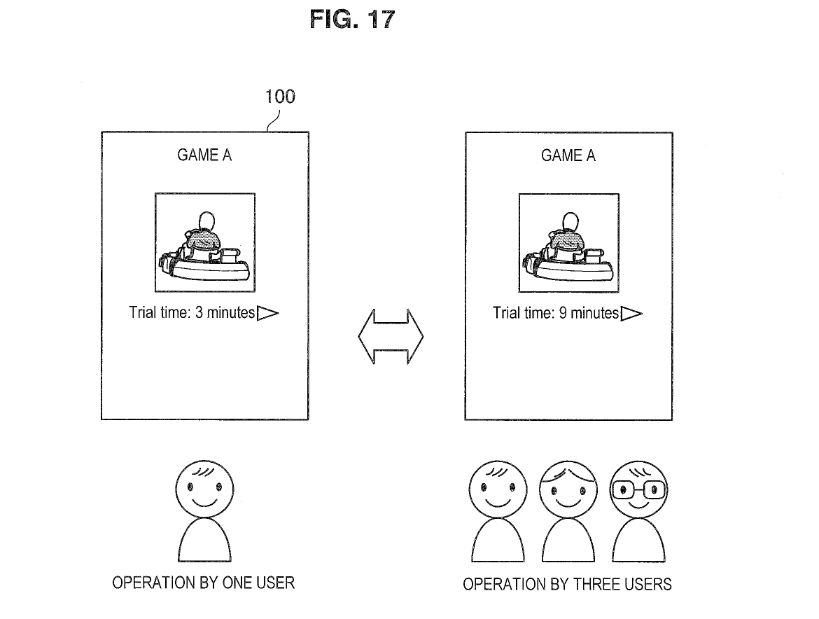

Based on FIG. 17, Embodiment Example 11 of the information-presentation-mode control method describes an information-presentation-mode control method by which a function of the device 100 is extended according to the number of users operating the device 100. FIG. 17 is an explanatory diagram for explaining change of an information presentation mode in extending a function of the device 100 according to the number of users operating the device 100 in Embodiment Example 11. The device 100 in the present embodiment example is, for example, a smartphone, a tablet terminal, a personal computer, or a television set. The present embodiment example describes, as an example of the function extension according to the number of users operating the device 100, a case of increasing time during which a function of the device 100 is executable.

For example, the device 100 executes a service function by which a certain game can be tried for a predetermined time. At this time, a game trial time is changed according to the number of users neighboring the device 100. For example, when one user uses the device 100, a 3-minute game trial time is set. In contrast, when three users use the device 100, a trial time three times longer than the trial time for one user, that is, a 9-minute trial time is provided. Such a game with enhanced enjoyment that increases a game trial time for more users playing the game is provided as described above. Trials by more users can thus be expected, and effective publicity can be given to the game, targeting the users.

In processing in the present embodiment example, for example, a camera used as the user detection apparatus 110 takes a photo of the neighborhood of the device 100, and image data is acquired as neighborhood information of the device 100. The image data acquired by the user detection apparatus 110 is outputted to the information processing apparatus 120. The information processing apparatus 120 causes the user analysis unit 122 to analyze the image data by using the face-image recognition technology, to identify any user neighboring the device 100, and to acquire the number of users as user attribute information. Then, based on the number of users, the user analysis unit 122 judges whether there is a change of the user operating the device 100 from a user in the previous processing.

If judging that there is a change of the number of users, the user analysis unit 122 outputs the acquired number of users to the IF control unit 126. Controlling an information presentation mode performed in the present embodiment example is controlling by which a function of the device 100 is extended according to the number of users operating the device 100, and thus the content of information to be provided does not have to be acquired. For this reason, in the present embodiment example, the number of users acquired by the user analysis unit 122 is outputted to the IF control unit 126, and the processing by the data control unit 124 is skipped. Note that if the processing is performed for the first time after the device 100 is started, the number of users is necessarily outputted to the IF control unit 126.

The IF control unit 126 receiving the number of users from the user analysis unit 122 calculates a game trial time according to the number of users operating the device 100. Then, the IF control unit 126 changes a remaining game trial time within the trial time calculated according to the number of the users. The users can play the game until the trial time expires. When the trial time expires, the IF control unit 126 disables the game and terminates the processing. Embodiment Example 11 has heretofore described the information-presentation-mode control method by which the function of the device 100 is extended according to the number of users operating the device 100. Applying the information-presentation-mode control method according to the present embodiment causes a function of the device 100 to be automatically extended according to the number of users operating the device 100, and thus effective publicity can be given to the function, targeting more users.

### 3.12. Embodiment Example 12

### Presenting Information in Accordance with Distance

As Embodiment Example 12 of the information-presentation-mode control method, there is an information-presentation-mode control method by which an information presentation mode provided by the device 100 is changed according to a distance between the device 100 and a user operating the device 100. In the present embodiment example, for example, a location sensor or a distance sensor is used as the user detection apparatus 110, as well as an imaging apparatus such as a camera, the location sensor enabling identification of the location of the user, the distance sensor enabling detection of a distance between the device 100 and the user. In other words, the distance between the user and the device 100 is used as user attribute information, the distance being detected by the user detection apparatus 110. The distance may use a value itself in the user detection apparatus 110, or may be acquired based on the analysis by the user analysis unit 122.

Acquiring the distance between the user and the device 100 as user attribute information enables change of, for example, the character size of information or sound volume to be provided for the user by using the device 100. As the distance between the user and the device 100 decreases, the IF control unit 126 increases, for example, the character size of information displayed on the IF apparatus 130 or the volume of sound outputted from the IF apparatus 130. This enables appropriate information output to be automatically adjusted based on a positional relationship between the device 100 and the user and can reduce trouble of manual adjustment by the user.

### 4. HARDWARE CONFIGURATION EXAMPLE

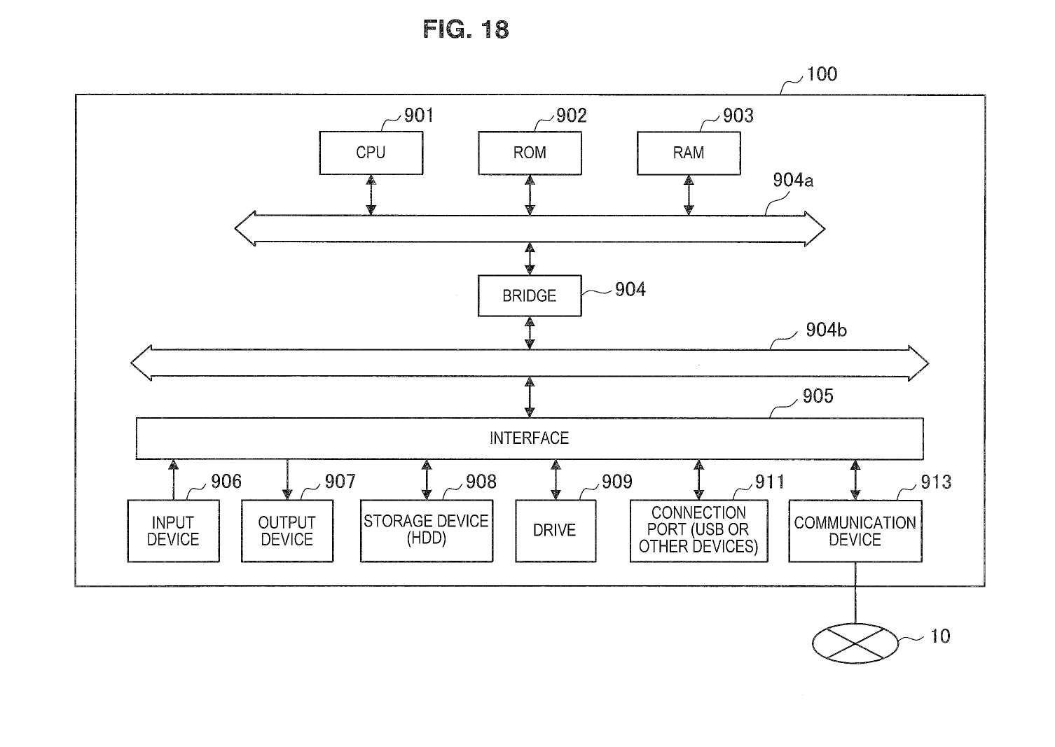

The processing by the device 100 according to the aforementioned embodiment can be executed by using hardware or software. In this case, the device 100 can be configured as illustrated in FIG. 18. Hereinafter, an example of a hardware configuration of the device 100 will be described based on FIG. 18.

The device 100 can be implemented by a processing apparatus such as a computer, as described above. As illustrated in FIG. 18, the device 100 includes a central processing unit (CPU) 901, a read only memory (ROM) 902, a random access memory (RAM) 903, and a host bus 904a. The device 100 also includes a bridge 904, an external bus 904b, an interface 905, an input device 906, an output device 907, a storage device (hard disk drive) 908, a drive 909, a connection port 911, and a communication device 913.

The CPU 901 functions as an arithmetic processing unit and a control unit, and controls overall operation of the device 100 according to a variety of programs. The CPU 901 may also be a microprocessor. The ROM 902 stores therein the programs, operational parameters, and the like that are used by the CPU 901. The RAM 903 temporarily stores therein the programs used and executed by the CPU 901, parameters appropriately varying in executing the programs, and the like. These are connected to each other through the host bus 904a configured of a CPU bus or the like.

The host bus 904a is connected to the external bus 904b such as a peripheral component interconnect/interface (PCI) bus through the bridge 904. Note that the host bus 904a, the bridge 904, and the external bus 904b do not have to be configured separately, and functions of these may be implemented by a single bus.

The input device 906 includes: an input unit for inputting information by a user, such as a mouse, a keyboard, a touch panel, buttons, a microphone, a switch, or a lever; an input control circuit generating input signals based on input by the user and outputting the signals to the CPU 901; and the like. The output device 907 includes: a display device such as a liquid crystal display (LCD) device, an organic light emitting diode (OLED) device, or a lamp; and an audio output device such as a speaker.

The storage device 908 is an example of a storage unit of the device 100 and is a device for storing data. The storage device 908 may include a storage medium, a recorder that records data in the storage medium, a reader that reads data from the storage medium, a deletion device that deletes data recorded in the storage medium, and the like. The storage device 908 is configured of, for example, a hard disk drive (HDD). The storage device 908 drives a hard disk and stores programs executed by the CPU 901 and a variety of data. The drive 909 is a reader/writer and is built in or externally connected to the device 100. The drive 909 reads information recorded in the removable recording medium loaded in the drive 909 such as a magnetic disk, an optical disk, a magneto-optical disk, or a semiconductor memory, and outputs the information to the RAM 903.

The connection port 911 is an interface connected to an external device, and is a port of connection with the external device capable of transferring data through, for example, an universal serial bus (USB). The communication device 913 is a communication interface configured of a communication device or the like for connecting to, for example, the communication network 10. The communication device 913 may be a communication device supporting a wireless local area network (LAN), a communication device supporting a wireless USB, or a wired communication device that performs wired communication.

### 5. CONCLUSION

The descriptions have heretofore been given of the device 100 according to the present embodiment, the information-presentation-mode control method used by the device 100, and the embodiment examples. The device 100 according to the present embodiment can provide information in a presentation mode appropriate for a user, while reducing an operation burden on the user. For example, information can be handled by using a UI suitable for a user of the device 100, or information suitable for the user can be presented. Also when a plurality of users operate the device 100, information can be handled by using a UI suitable for the corresponding user, and information suitable for the user can be presented. Further, a function can be automatically and appropriately restricted and extended for any other user than the owner of the device 100 or the owner of information.

It should be understood by those skilled in the art that various modifications, combinations, sub-combinations and alterations may occur depending on design requirements and other factors insofar as they are within the scope of the appended claims or the equivalents thereof.

In addition, the advantageous effects described in the specification are merely explanatory or illustrative, and are not limited. In other words, the technology according to the present disclosure can exert other advantageous effects that are clear to those skilled in the art from the description of the specification, in addition to or instead of the advantageous effects described above.

Additionally, the present technology may also be configured as below:
(1) An information processing apparatus including:

a user analysis unit configured to analyze a result of detection by a user detection apparatus that detects users neighboring a device and to acquire user attribute information indicating a characteristic of each detected user; and

an interface control unit configured to control a mode of presenting information to be provided for the users, the mode being determined based on the user attribute information.
(2) The information processing apparatus according to (1),

wherein a user ID associated with at least one of face information, voice information, age, and gender is registered in advance for each user, and

wherein the user analysis unit analyzes the result of detection by the user detection apparatus and acquires the user ID as the user attribute information.
(3) The information processing apparatus according to (1) or (2),

wherein the user analysis unit analyzes the result of detection by the user detection apparatus and acquires as the user attribute information at least one of gender of the user, age of the user, a distance between the user and the device, and an eye-gaze state of the user.
(4) The information processing apparatus according to (2) or (3),

wherein the user analysis unit analyzes the result of detection by the user detection apparatus by using at least one of face-image recognition technology, eye-gaze recognition technology, and speaker recognition technology, and acquires the user attribute information.
(5) The information processing apparatus according to any one of (1) to (4), further including:

an information control unit configured to determine information to be provided for the users,

wherein when the information to be provided for the users has access authorization information indicating whether or not access to the information to be provided is allowed, the information control unit determines information allowed to be provided for the users based on the access authorization information of the information to be provided and on the acquired user attribute information of all of the users.
(6) The information processing apparatus according to any one of (1) to (4),

wherein the interface control unit controls the mode of presenting information to be presented to the users, based on the user attribute information and in accordance with availability of operating the device.
(7) The information processing apparatus according to any one of (1) to (4),

wherein the interface control unit controls the mode of presenting information to be provided for the users, based on the user attribute information and in accordance with display or non-display on the device.
(8) The information processing apparatus according to any one of (1) to (4),

wherein when recognizing all of users allowed to share the information to be presented to the users based on the user attribute information, the interface control unit enables the information to be provided for the users to be edited.
(9) The information processing apparatus according to any one of (1) to (4),

wherein the interface control unit changes a function of the device based on the user attribute information, the function being to be provided for the users.
(10) The information processing apparatus according to any one of (1) to (4),

wherein the interface control unit changes the information to be provided for the users based on the number of users acquired from the result of detection by the user detection apparatus.
(11) The information processing apparatus according to any one of (1) to (4),

wherein the interface control unit changes the mode of presenting information to be provided for the users, based on the user attribute information and in accordance with additional information.
(12) The information processing apparatus according to any one of (1) to (11),

wherein the users detected by the user detection apparatus are users allowed to simultaneously share information by using respective devices connected to each other through a network.
(13) The information processing apparatus according to any one of (1) to (12),

wherein the user detection apparatus is at least one of an imaging apparatus and a voice acquisition apparatus.
(14) An information processing method including:

analyzing, by a user analysis unit, a result of detection by a user detection apparatus that detects users neighboring a device and to acquire user attribute information indicating a characteristic of each detected user; and

controlling, by an interface control unit, a mode of presenting information to be provided for the users, the mode being determined based on the user attribute information.

What is claimed is:

1. An information processing apparatus comprising:
a user analysis unit configured to analyze a result of detection by a user detection apparatus that detects users neighboring a device and to acquire user attribute information indicating a characteristic of each detected user; and
an interface control unit configured to control a mode of presenting information to be provided for the users, the mode being determined based on the user attribute information.

2. The information processing apparatus according to claim 1,
wherein a user ID associated with at least one of face information, voice information, age, and gender is registered in advance for each user, and
wherein the user analysis unit analyzes the result of detection by the user detection apparatus and acquires the user ID as the user attribute information.

3. The information processing apparatus according to claim 1,
wherein the user analysis unit analyzes the result of detection by the user detection apparatus and acquires as the user attribute information at least one of gender of the user, age of the user, a distance between the user and the device, and an eye-gaze state of the user.

4. The information processing apparatus according to claim 2,
wherein the user analysis unit analyzes the result of detection by the user detection apparatus by using at least one of face-image recognition technology, eye-gaze recognition technology, and speaker recognition technology, and acquires the user attribute information.

5. The information processing apparatus according to claim 1, further comprising:
an information control unit configured to determine information to be provided for the users,
wherein when the information to be provided for the users has access authorization information indicating whether or not access to the information to be provided is allowed, the information control unit determines information allowed to be provided for the users based on the access authorization information of the information to be provided and on the acquired user attribute information of all of the users.

6. The information processing apparatus according to claim 1,
wherein the interface control unit controls the mode of presenting information to be presented to the users, based on the user attribute information and in accordance with availability of operating the device.

7. The information processing apparatus according to claim 1,
wherein the interface control unit controls the mode of presenting information to be provided for the users, based on the user attribute information and in accordance with display or non-display on the device.

8. The information processing apparatus according to claim 1,
wherein when recognizing all of users allowed to share the information to be presented to the users based on the user attribute information, the interface control unit enables the information to be provided for the users to be edited.

9. The information processing apparatus according to claim 1,
wherein the interface control unit changes a function of the device based on the user attribute information, the function being to be provided for the users.

10. The information processing apparatus according to claim 1,
wherein the interface control unit changes the information to be provided for the users based on the number of users acquired from the result of detection by the user detection apparatus.

11. The information processing apparatus according to claim 1,
wherein the interface control unit changes the mode of presenting information to be provided for the users, based on the user attribute information and in accordance with additional information.

12. The information processing apparatus according to claim 1,
wherein the users detected by the user detection apparatus are users allowed to simultaneously share information by using respective devices connected to each other through a network.

13. The information processing apparatus according to claim 1,
wherein the user detection apparatus is at least one of an imaging apparatus and a voice acquisition apparatus.

14. An information processing method comprising:
analyzing, by a user analysis unit, a result of detection by a user detection apparatus that detects users neighboring a device and to acquire user attribute information indicating a characteristic of each detected user; and
controlling, by an interface control unit, a mode of presenting information to be provided for the users, the mode being determined based on the user attribute information.
